(19) United States
(12) Patent Application Publication
(10) Pub. No.: US 2025/0088211 A1
(43) Pub. Date: Mar. 13, 2025

(54) ELECTRONIC DEVICE COMPRISING ANTENNA

(71) Applicant: Samsung Electronics Co., Ltd., Suwon-si (KR)

(72) Inventors: Jangsun YOO, Suwon-si (KR); Hakjin KIM, Suwon-si (KR); Jihye MOON, Suwon-si (KR); Youngheon SONG, Suwon-si (KR); Myeonggil LEE, Suwon-si (KR); Heeseung LEE, Suwon-si (KR); Gun LIM, Suwon-si (KR)

(21) Appl. No.: 18/960,534

(22) Filed: Nov. 26, 2024

Related U.S. Application Data
(63) Continuation of application No. PCT/KR2023/008337, filed on Jun. 16, 2023.

(30) Foreign Application Priority Data
Jun. 29, 2022 (KR) 10-2022-0079699
Aug. 12, 2022 (KR) 10-2022-0101280

(51) Int. Cl. H04B 1/50; H04B 1/401

(52) U.S. Cl. CPC H04B 1/50; H04B 1/401

(57) ABSTRACT

An electronic device is provided. The electronic device includes a housing including a conductive portion, the conductive portion including a first segment and a second segment separated from the first segment by a first gap, a first switch configured to selectively connect the first segment and the second segment, a first wireless communication circuit including a first port and a second port, the first port being electrically connected to the first segment, and a second switch configured to selectively connect the second port and the second segment, wherein the first wireless communication circuit is configured to operate in a first mode or a second mode, wherein the first mode is configured to transmit and/or receive a wireless signal in a first frequency range by using a first antenna formed from the first segment electrically open to the second segment through the first switch, and transmit and/or receive the wireless signal in the first frequency range by using a second antenna formed from the second segment electrically open to the first segment through the first switch and electrically connected to the second port through the second switch, wherein the second mode is configured to transmit and/or receive a wireless signal in the first frequency range and a second frequency range by using a third antenna formed from the first segment electrically connected to the second segment through the first switch and the second segment electrically open to the second port through the second switch, and wherein the second frequency range is different from the first frequency range.

### CROSS-REFERENCE TO RELATED APPLICATION(S)

This application is a continuation application, claiming priority under § 365(c), of an International application No. PCT/KR2023/008337, filed on Jun. 16, 2023, which is based on and claims the benefit of a Korean patent application number 10-2022-0079699, filed on Jun. 29, 2022, in the Korean Intellectual Property Office, and of a Korean patent application number 10-2022-0101280, filed on Aug. 12, 2022, in the Korean Intellectual Property Office, the disclosure of each of which is incorporated by reference herein in its entirety.

### BACKGROUND

### 1. Field

The disclosure relates to an electronic device including an antenna.

### 2. Description of Related Art

Nowadays, with the development of electronic technology, various electronic devices, such as smart phones, tablet personal computers, and notebook personal computers are becoming widespread.

An electronic device may include a plurality of antennas to implement mobile communication technologies, such as long term evolution carrier aggregation (LTE CA) and 5^{th} generation (5G) communication.

The plurality of antennas may include housing for forming the exterior appearance of the electronic device as an antenna element. For example, the housing of the electronic device may include conductive portions including a conductive material (e.g., metal), and the conductive portions may operate as radiating elements for propagating wireless signals.

The above information is presented as background information only to assist with an understanding of the disclosure. No determination has been made, and no assertion is made, as to whether any of the above might be applicable as prior art with regard to the disclosure.

### SUMMARY

The housing of an electronic device may be provided with a connector for connecting an external device. Because a conductive portion of the housing for forming an antenna of the electronic device needs to be provided to avoid the connector of the housing, it may be difficult to satisfy the physical length of a conductive portion for supporting the required communication frequency band.

For example, a notebook PC may include upper housing and lower housing that are pivotally coupled about a hinge part. In general, a substrate including a processor and/or a communication circuit is placed in the lower housing, which touches a bottom when it is used, and a display may be placed in the upper housing. A plurality of connectors on the notebook PC may be provided on the lower housing for convenience of use. Moreover, the antenna of the notebook PC may be formed by conductive portions of the lower housing for the shortest connection with a communication circuit inside the lower housing. Because the resonant frequency of an antenna depends on physical lengths of the conductive portions, it may be difficult to provide a conductive portion having a relatively long length for a low frequency band while the plurality of connectors are avoided in the lower housing, for example. In the meantime, the housing of the electronic device may be vulnerable to external impact due to the conductive portion having the relatively long length.

Aspects of the disclosure are to address at least the above-mentioned problems and/or disadvantages and to provide at least the advantages described below. Accordingly, an aspect of the disclosure is to provide an electronic device comprising antenna.

Additional aspects will be set forth in part in the description which follows and, in part, will be apparent from the description, or may be learned by practice of the presented embodiments.

In accordance with an aspect of the disclosure, an electronic device is provided. The electronic device includes a housing including a conductive portion, the conductive portion including a first segment, and a second segment separated from the first segment by a first gap, a first switch configured to selectively connect the first segment and the second segment, a first wireless communication circuit including a first port and a second port, the first port being electrically connected to the first segment, and a second switch configured to selectively connect the second port and the second segment, wherein the first wireless communication circuit is configured to operate in a first mode or a second mode, wherein the first mode is configured to transmit and/or receive a wireless signal in a first frequency range by using a first antenna formed from the first segment electrically open to the second segment through the first switch, and transmit and/or receive a wireless signal in the first frequency range by using a second antenna formed from the second segment electrically open to the first segment through the first switch and electrically connected to the second port through the second switch, wherein the second mode is configured to transmit and/or receive a wireless signal in the first frequency range and a second frequency range by using a third antenna formed from the first segment electrically connected to the second segment through the first switch and the second segment electrically open to the second port through the second switch, and wherein the second frequency range is different from the first frequency range.

In accordance with another aspect of the disclosure, an electronic device is provided. The electronic device includes a housing including a conductive portion, the conductive portion including a plurality of segments, and the plurality of segments being respectively separated by a plurality of gaps, a wireless communication circuit configured to perform wireless communication by using at least one of the plurality of segments as an antenna, a proximity sensor configured to detect whether an external object is in proximity, memory storing one or more computer programs, and one or more processors communicatively coupled to the wireless communication circuit and the proximity sensor, wherein the one or more computer programs include computer-executable instructions that, when executed by the one or more processors individually or collectively, cause the electronic device to determine whether an external object is close to a first specified segment among the plurality of segments at a specified level or higher, through the proximity sensor, determine whether the first specified segment is electrically connected to a second specified segment among the plurality of segments based on an external object being identified as being close to the first specified segment at the specified level or higher, determine whether an external object is close to a third specified segment among the plurality of segments at the specified level or higher, based on the first specified segment being identified as being electrically connected to the second specified segment, and electrically connect the second specified segment and the third specified segment, based on an external object being identified as being close to the third specified segment at less than the specified level.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include determining whether an external object is close to a first specified segment among a plurality of segments at a specified level or higher, through a proximity sensor, the plurality of segments included in a conductive portion of a housing of the electronic device and separated by plurality of gapes, determining whether the first specified segment is electrically connected to a second specified segment among the plurality of segments based on the external object being identified as being close to the first specified segment at the specified level or higher, determining whether the external object is close to a third specified segment among the plurality of segments at the specified level or higher, based on the first specified segment being identified as being electrically connected to the second specified segment, and electrically connecting the second specified segment and the third specified segment, based on the external object being identified as being close to the third specified segment at less than the specified level.

According to various embodiments of the disclosure, an electronic device supports various wireless communication frequency bands while maintaining the rigidity of housing, by using a plurality of segments included in the housing as an antenna individually or in combination depending on communication situations.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a plan view illustrating a front exterior appearance of an electronic device according to an embodiment of the disclosure;

FIG. 3 is a block diagram of an electronic device according to an embodiment of the disclosure;

FIG. 4 is a block diagram illustrating a connection relationship between components when a first wireless communication circuit of an electronic device operates in a first mode according to an embodiment of the disclosure;

FIG. 5 is a block diagram illustrating a connection relationship between components when a first wireless communication circuit of an electronic device operates in a second mode according to an embodiment of the disclosure;

FIG. 6 is a block diagram of an electronic device according to an embodiment of the disclosure;

FIG. 7 is a block diagram illustrating a connection relationship between components when a first wireless communication circuit of an electronic device operates in a first mode according to an embodiment of the disclosure;

FIG. 8 is a block diagram illustrating a connection relationship between components when a first wireless communication circuit of an electronic device operates in a second mode according to an embodiment of the disclosure;

FIG. 9 is a block diagram illustrating a connection relationship between components when a first wireless communication circuit of an electronic device operates in a third mode according to an embodiment of the disclosure;

FIG. 10 is a block diagram of an electronic device according to an embodiment of the disclosure;

FIG. 11 is a block diagram illustrating a connection relationship between components when a first wireless communication circuit of an electronic device operates in a first mode according to an embodiment of the disclosure;

FIG. 12 is a block diagram illustrating a connection relationship between components when a first wireless communication circuit of an electronic device operates in a second mode according to an embodiment of the disclosure;

FIG. 13 is a block diagram illustrating a connection relationship between segments when a first wireless communication circuit of an electronic device operates in a fourth mode according to an embodiment of the disclosure;

FIG. 14 is a flowchart of an operation of an electronic device according to an embodiment of the disclosure; and

FIG. 15 is a flowchart of an operation of an electronic device according to an embodiment of the disclosure.

Throughout the drawings, like reference numerals will be understood to refer to like parts, components and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

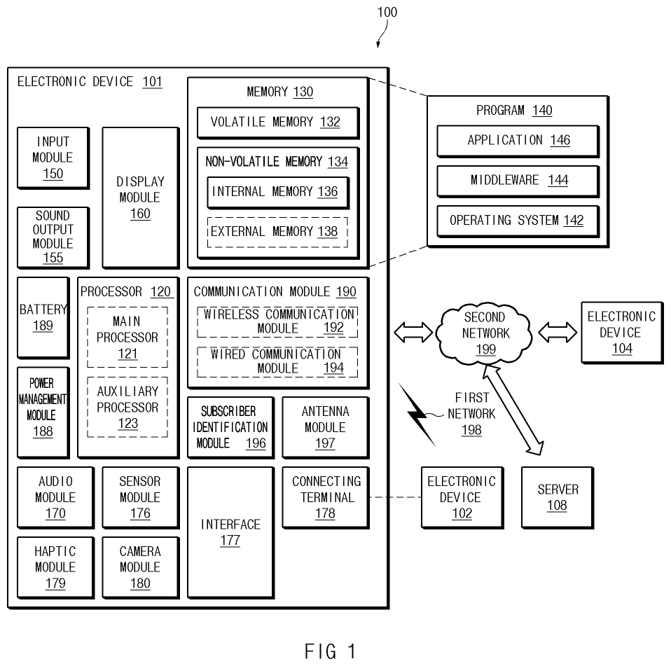

FIG. 1 is a block diagram of an electronic device in a network environment according to an embodiment of the disclosure.

Referring to FIG. 1, an electronic device 101 in environment information 100 may communicate with an external electronic device 102 over a first network 198 (e.g., a short range wireless communication network) or may communicate with at least one of an external electronic device 104 or a server 108 over a second network 199 (e.g., a long distance wireless communication network). According to an embodiment of the disclosure, the electronic device 101 may communicate with the external electronic device 104 through the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module 196, or an antenna module 197. In any embodiment of the disclosure, the electronic device 101 may not include at least one (e.g., the connecting terminal 178) of the above-described components or may further include one or more other components. In some embodiments of the disclosure, some (e.g., the sensor module 176, the camera module 180, or the antenna module 197) of these components may be integrated into a single component (e.g., the display module 160).

For example, the processor 120 may execute software (e.g., a program 140) to control at least another component (e.g., hardware or software component) of the electronic device 101 connected to the processor 120, and may process and calculate various types of data. According to an embodiment of the disclosure, as at least part of data processing or calculation, the processor 120 may store instructions or data received from other components (e.g., the sensor module 176 or the communication module 190) into volatile memory 132, may process instructions or data stored in the volatile memory 132, and may store the result data in nonvolatile memory 134. According to an embodiment of the disclosure, the processor 120 may include a main processor 121 (e.g., a central processing unit or an application processor) and an auxiliary processor 123 (e.g., a graphic processing unit, a neural processing unit (NPU), an image signal processor, a sensor hub processor, or a communication processor) capable of operating independently or together with the main processor. For example, when the electronic device 101 includes the main processor 121 and the auxiliary processor 123, the auxiliary processor 123 may be configured to use less power than the main processor 121 or to be specialized for a specified function. The auxiliary processor 123 may be implemented separately from the main processor 121 or as part of the main processor 121.

For example, the auxiliary processor 123 may control at least part of the functions or states associated with at least one (e.g., the display module 160, the sensor module 176, or the communication module 190) of the components of the electronic device 101, instead of the main processor 121 while the main processor 121 is in an inactive (e.g., a sleep) state or together with the main processor 121 while the main processor 121 is in an active (e.g., the execution of an application) state. According to an embodiment of the disclosure, the auxiliary processor 123 (e.g., an image signal processor or a communication processor) may be implemented as a part of operatively associated other components (e.g., the camera module 180 or the communication module 190). According to an embodiment of the disclosure, the auxiliary processor 123 (e.g., a neural network processing unit) may include a hardware structure specialized to process an artificial intelligence model. The artificial intelligence model may be generated through machine learning. For example, the learning may be performed in the electronic device 101, in which an artificial intelligence model is performed, or may be performed through a separate server (e.g., the server 108). For example, the learning algorithm may include supervised learning, unsupervised learning, semi-supervised learning, or reinforcement learning, but is not limited to the above example. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more of the networks, but may not be limited to the above-described example. In addition to a hardware structure, additionally or alternatively, the artificial intelligence model may include a software structure.

The memory 130 may store various pieces of data used by at least one component (e.g., the processor 120 or the sensor module 176) of the electronic device 101. For example, data may include software (e.g., the program 140) and input data or output data for instructions associated with the software. The memory 130 may include the volatile memory 132 or the nonvolatile memory 134.

The program 140 may be stored in the memory 130 as software, and may include, for example, an operating system 142, a middleware 144, or an application 146.

The input module 150 may receive instructions or data to be used for the component (e.g., the processor 120) of electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for a general purpose, such as multimedia play or recording play. The receiver may be used to receive an incoming call. According to an embodiment of the disclosure, the receiver may be implemented separately from the speaker or may be implemented as a part of the speaker.

The display module 160 may visually provide information to the outside (e.g., the user) of the electronic device 101. The display module 160 may include, for example, a display, a hologram device, or a control circuit for controlling a projector and a corresponding device. According to an embodiment of the disclosure, the display module 160 may include a touch sensor configured to detect a touch, or a pressure sensor configured to measure the strength of force generated by the touch.

The audio module 170 may convert sound to an electrical signal, or reversely, may convert an electrical signal to sound. According to an embodiment of the disclosure, the audio module 170 may obtain sound through the input module 150, or may output sound through the sound output module 155, or through an external electronic device (e.g., the external electronic device 102) (e.g., a speaker or a headphone) directly or wirelessly connected with the electronic device 101.

The sensor module 176 may detect an operation state (e.g., power or a temperature) of the electronic device 101 or an external environment state (e.g., a user state), and may generate an electrical signal or a data value corresponding the detected state. According to an embodiment of the disclosure, the sensor module 176 may include, for example, a gesture sensor, a gyro sensor, a barometric pressure sensor, a magnetic sensor, an acceleration sensor, a grip sensor, a proximity sensor, a color sensor, an infrared (IR) sensor, a biometric sensor, a temperature sensor, a humidity sensor, or an illumination sensor.

The interface 177 may support one or more specified protocols that may be used to directly and wirelessly connect the electronic device 101 with an external electronic device (e.g., the external electronic device 102). According to an embodiment of the disclosure, the interface 177 may include, for example, a high-definition multimedia interface (HDMI), a universal serial bus (USB) interface, a secure digital (SD) card interface, or an audio interface.

The connecting terminal 178 may include a connector that may allow the electronic device 101 to be physically connected with an external electronic device (e.g., the external electronic device 102). According to an embodiment of the disclosure, the connecting terminal 178 may include, for example, a HDMI connector, an USB connector, an SD card connector, or an audio connector (e.g., a headphone connector).

The haptic module 179 may convert an electrical signal to a mechanical stimulation (e.g., vibration or movement) or an electrical stimulation which the user may perceive through the sense of touch or the sense of movement. According to an embodiment of the disclosure, the haptic module 179 may include, for example, a motor, a piezoelectric sensor, or an electrical stimulation device.

The camera module 180 may shoot a still image or a video image. According to an embodiment of the disclosure, the camera module 180 may include one or more lenses, image sensors, image signal processors, or flashes (or electrical flashes).

The power management module 188 may manage the power which is supplied to the electronic device 101. According to an embodiment of the disclosure, the power management module 188 may be implemented, for example, as at least part of a power management integrated circuit (PMIC).

The battery 189 may power at least one component of the electronic device 101. According to an embodiment of the disclosure, the battery 189 may include, for example, a primary cell not rechargeable, a secondary cell rechargeable, or a fuel cell.

The communication module 190 may establish a direct (or wired) communication channel or a wireless communication channel between the electronic device 101 and an external electronic device (e.g., the external electronic device 102, the external electronic device 104, or the server 108) and may perform communication through the established communication channel. The communication module 190 may include one or more communication processors which are operated independently of the processor 120 (e.g., an application processor) and support direct (or wired) communication or wireless communication. According to an embodiment of the disclosure, the communication module 190 may include a wireless communication module 192 (e.g., a cellular communication module, a short range wireless communication module, or a global navigation satellite system (GNSS) communication module) or a wired communication module 194 (e.g., a local area network (LAN) communication module or a power line communication module). The corresponding communication module among these communication modules may communicate with an external electronic device 104 through a first network 198 (e.g., a short-range communication network, such as Bluetooth, wireless fidelity (Wi-Fi) direct or infrared data association (IrDA)) or a second network 199 (e.g., long-range wireless communication network, such as a legacy cellular network, 5G networks, next-generation communication networks, Internet, or computer networks (e.g., LAN or wide area network (WAN)). The above-described kinds of communication modules may be integrated in one component (e.g., a single chip) or may be implemented with a plurality of components (e.g., a plurality of chips) which are independent of each other. The wireless communication module 192 may identify or authenticate the electronic device 101 within a communication network, such as the first network 198 or the second network 199, by using subscriber information (e.g., international mobile subscriber identity (IMSI)) stored in the subscriber identification module 196.

The wireless communication module 192 may support a 5G network and a next-generation communication technology after a 4^{th} generation (4G) network, for example, a new radio (NR) access technology. The NR access technology may support enhanced mobile broadband (eMBB), massive machine type communications (mMTC), or ultra-reliable and low-latency communications (URLLC). For example, the wireless communication module 192 may support a high frequency band (e.g., mmWave band) to achieve a high data transfer rate. The wireless communication module 192 may support various technologies for securing performance in a high frequency band, for example, technologies, such as beamforming, massive multiple-input and multiple-output (massive MIMO), full dimensional MIMO (FD-MIMO), an array antenna, analog beam-forming, and a large scale antenna. The wireless communication module 192 may support various requirements regulated in the electronic device 101, an external electronic device (e.g., the external electronic device 104) or a network system (e.g., the second network 199). According to an embodiment of the disclosure, the wireless communication module 192 may support peak data rate (e.g., 20 Gbps or more) for eMBB implementation, loss coverage (e.g., 164 dB or less) for mMTC implementation, or U-plane latency (e.g., downlink (DL) of 0.5 ms or less and uplink (UL) of 0.5 ms or less, or round trip of 1 ms or less) for URLLC implementation.

The antenna module 197 may transmit a signal or a power to the outside (e.g., an external electronic device) or may receive a signal or a power from the outside. According to an embodiment of the disclosure, the antenna module 197 may include an antenna including a radiator formed of a conductor or a conductive pattern formed on a substrate (e.g., printed circuit board (PCB)). According to one embodiment of the disclosure, the antenna module 197 may include a plurality of antennas (e.g., an array antenna). In this case, at least one antenna suitable for a communication scheme used in a communication network, such as the first network 198 or the second network 199 may be selected, for example, by the communication module 190 from the plurality of antennas. The signal or power may be exchanged between the communication module 190 and an external electronic device through the selected at least one antenna or may be received from the external electronic device through the selected at least one antenna and the communication module 190. According to some embodiments of the disclosure, other parts (e.g., radio frequency integrated circuit (RFIC)) may be additionally formed as a part of the antenna module 197 in addition to the radiator.

According to various embodiments of the disclosure, the antenna module 197 may form an mmWave antenna module. According to an embodiment of the disclosure, the mmWave antenna module may include a printed circuit board (PCB), a radio frequency integrated circuit (RFIC), and a plurality of antennas (e.g., an array antenna). The RFIC may be disposed on or adjacent to a first surface (e.g., a bottom surface) of the PCB and may support a specified high frequency band (e.g., mm Wave band). The plurality of antennas may be disposed on or adjacent to a second surface (e.g., a top surface or a side surface) of the PCB and may transmit or receive a signal in the specified high frequency band.

At least some of the components may be connected to each other through a communication scheme (e.g., a bus, a general purpose input and output (GPIO), a serial peripheral interface (SPI), or a mobile industry processor interface (MIPI)) between peripheral devices and may exchange signals (e.g., commands or data) with each other.

According to an embodiment of the disclosure, the command or data may be transmitted or received between the electronic device 101 and the external electronic device 104 through the server 108 connected to the second network 199. Each of the external electronic device 102 or 104 may be a device of which the type is the same as or different from that of the electronic device 101. According to an embodiment of the disclosure, all or a part of operations to be executed by the electronic device 101 may be executed in one or more external electronic devices among the external electronic devices 102 or 104, or the server 108. For example, when the electronic device 101 needs to perform any function or service automatically or in response to a request from the user or any other device, the electronic device 101 may additionally request one or more external electronic devices to perform at least part of the function or service, instead of internally executing the function or service. The one or more external electronic devices which receive the request may execute at least a part of the function or service thus requested or an additional function or service associated with the request, and may provide a result of the execution to the electronic device 101. The electronic device 101 may process the result as it is or additionally, and may provide a result of the processing as at least a part of the response to the request. To this end, for example, cloud computing, distributed computing, mobile edge computing (MEC), or client-server computing may be used. For example, the electronic device 101 may provide an ultra-low latency service by using distributed computing or mobile edge computing. In another embodiment of the disclosure, the external electronic device 104 may include an Internet of things (IoT) device. The server 108 may be an intelligent server using machine learning and/or a neural network. According to an embodiment of the disclosure, the external electronic device 104 or the server 108 may be included in the second network 199. The electronic device 101 may be applied to an intelligent service (e.g., a smart home, a smart city, a smart car, or a healthcare) based on 5G communication technology and IoT-related technology.

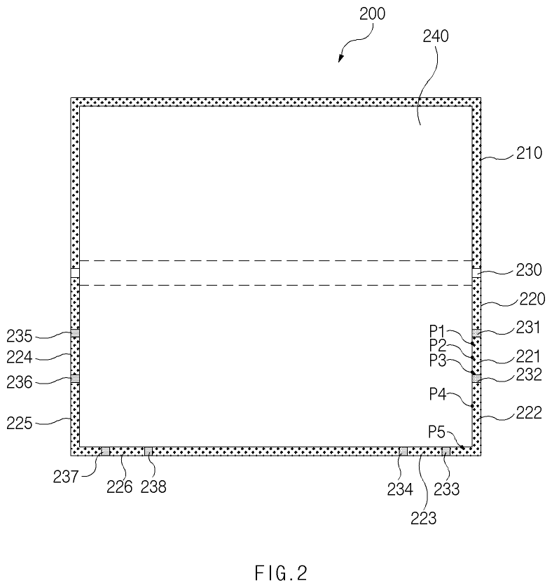

FIG. 2 is a plan view illustrating a front exterior appearance of an electronic device according to an embodiment of the disclosure.

Referring to FIG. 2, an electronic device 200 (e.g., the electronic device 101 of FIG. 1) according to an embodiment of the disclosure may include first housing 210, second housing 220, a hinge part 230, and a display 240.

According to an embodiment of the disclosure, the first housing 210, the second housing 220, and the display 240 may at least partially define an exterior appearance of the electronic device 200. For example, the display 240 may be at least partially accommodated in the first housing 210 and the second housing 220 to form a front surface of the electronic device 200 together with the first housing 210 and the second housing 220. The first housing 210 and the second housing 220 may form a rear surface facing in the opposite direction of the front surface, and a side surface surrounding the space between the front surface and the rear surface. However, it is not limited to the example described above.

According to an embodiment of the disclosure, the display 240 may be visually exposed through at least part of the front surface. The display 240 may include a flexible display or a foldable display that is at least partially deformable.

According to an embodiment of the disclosure, the first housing 210 may be connected to the second housing 220 through the hinge part 230. For example, the first housing 210 and the second housing 220 may be pivotally coupled to each other through the hinge part 230. The first housing 210 and the second housing 220 may rotate around the hinge part 230 such that the electronic device 200 is capable of being folded or unfolded.

According to an embodiment of the disclosure, the second housing 220 may include a conductive portion and a non-conductive portion. The conductive portion of the second housing 220 may include a conductive material (e.g., metal). The conductive portion of the second housing 220 may include a plurality of segments. For example, the plurality of segments may include a first segment 221, a second segment 222, a third segment 223, a fourth segment 224, a fifth segment 225, and/or a sixth segment 226. According to an embodiment of the disclosure, the plurality of segments of the second housing 220 may operate as the antenna of the electronic device 200.

According to an embodiment of the disclosure, the plurality of segments may include a plurality of points P1, P2, P3, P4, and/or P5 capable of being electrically connected to at least one component of the electronic device 200. For example, the first segment 221 may include the first point P1, the second point P2, and/or the third point P3. Here, the first point P1 may be placed closer to a first gap 231 than a second gap 232, the third point P3 may be placed closer to the second gap 232 than the first gap 231, and, the second point P2 may be placed between the first point P1 and the third point P3. Moreover, the second segment 222 may include the fourth point P4 and/or the fifth point P5. Here, the fourth point P4 may be placed closer to the second gap 232 than a third gap 233, and the fifth point P5 may be placed closer to the third gap 233 than the second gap 232. According to an embodiment of the disclosure, the plurality of points P1, P2, P3, P4, and/or P5 may mean electrical connection points capable of being electrically connected to at least one component of the electronic device 200. For example, they may include connection points in contact with a connection member (e.g., c-clip) placed on a printed circuit board (not shown).

According to an embodiment of the disclosure, the non-conductive portion of the second housing 220 may include at least one gap. For example, the non-conductive portion of the second housing 220 may include the first gap 231, the second gap 232, the third gap 233, a fourth gap 234, a fifth gap 235, a sixth gap 236, a seventh gap 237, and/or an eighth gap 238. The at least one gap may include a non-conductive material. For example, the at least one gap may be at least partially filled with the non-conductive material, such as air or resin.

The at least one gap may at least partially separate a plurality of segments of the conductive portion. For example, the first segment 221 and the second segment 222 may be separated from each other by the second gap 232, and the second segment 222 and the third segment 223 may be separated from each other by the third gap 233. For example, the plurality of segments may be at least partially spaced apart from neighboring segments by at least one gap. For example, the fourth segment 224 may be at least partially spaced apart from the fifth segment 225, which is neighboring, by the sixth gap 236.

At least one gap and the plurality of segments of the second housing 220 may form at least part of a side surface of the second housing 220. Additionally or alternatively, the at least one gap and the plurality of segments of the second housing 220 may form a portion of a front surface and/or a portion of a rear surface of the second housing 220.

According to various embodiments of the disclosure, the at least one gap and the plurality of segments of the second housing 220 may be implemented with various lengths depending on specifications of the electronic device 200. For example, the at least one gap and the plurality of segments of the second housing 220 may be implemented with various lengths depending on various wireless communication standards and corresponding wireless communication frequency bands supported by the electronic device 200.

FIG. 2 illustrates a foldable electronic device in which a first housing 210 and a second housing 220 of an electronic device 200 are capable of being folded around a hinge part 230, but is not limited thereto. For example, the electronic device 200 may include single housing in which the first housing 210 and the second housing 220 are integrally formed, and may not include the hinge part 230. In this case, the electronic device 200 may be an electronic device including single non-foldable housing.

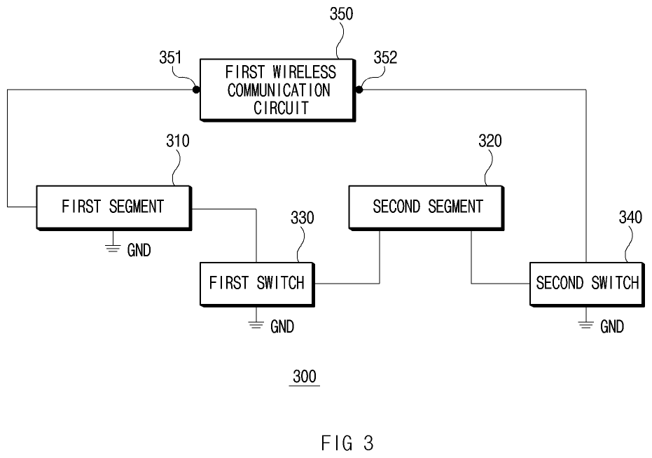

Hereinafter, an embodiment in which an electronic device 300 utilizes a first segment 310 and a second segment 320 as an antenna will be described with reference to FIGS. 3, 4, and 5.

FIG. 3 is a block diagram of an electronic device according to an embodiment of the disclosure.

Referring to FIG. 3, the electronic device 300 (e.g., the electronic device 101 of FIG. 1 or the electronic device 200 of FIG. 2) may include the first segment 310 (e.g., the first segment 221 of FIG. 2), the second segment 320 (e.g., the second segment 222 of FIG. 2), a first switch 330, a second switch 340, and a first wireless communication circuit 350 (e.g., the wireless communication module 192 of FIG. 1).

According to an embodiment of the disclosure, the first segment 310 may be electrically connected to a first port 351 of the first wireless communication circuit 350, a ground part, and the first switch 330. For example, the first segment 310 may be electrically connected to the first port 351 of the first wireless communication circuit 350 at a first point. For example, the first point may include, but is not limited to, the first point P1 of FIG. 2. The first segment 310 may be electrically connected to the ground part at the second point. For example, the second point may include, but is not limited to, the first point P1 or the second point P2 of FIG. 2. The first segment 310 may be electrically connected to the first switch 330 at a third point. For example, the third point may include, but is not limited to, the third point P3 of FIG. 2.

According to an embodiment of the disclosure, the second segment 320 may be electrically connected to the first switch 330 and the second switch 340. For example, the second segment 320 may be electrically connected to the second switch 340 at the first point. For example, the first point may include, but is not limited to, the fourth point P4 of FIG. 2. The second segment 320 may be electrically connected to the first switch 330 at a second point. For example, the second point may include, but is not limited to, the fifth point P5 of FIG. 2.

According to an embodiment of the disclosure, the first segment 310 and/or the second segment 320 may radiate an electrical signal received from the first wireless communication circuit 350 into external space. According to an embodiment of the disclosure, each of the first segment 310 and the second segment 320 may have a specified length. For example, the first segment 310 and/or the second segment 320 may have a length capable of transmitting and/or receiving a wireless signal in the first frequency range. In this case, the first segment 310 and the second segment 320, which are connected to each other, may each have a length capable of transmitting and/or receiving wireless signals in a first frequency range and a second frequency range.

According to an embodiment of the disclosure, the first switch 330 may be electrically connected to the first segment 310, the ground part, and the second segment 320. According to an embodiment of the disclosure, the first switch 330 may selectively connect the second segment 320 to the first segment 310 or the ground part.

According to an embodiment of the disclosure, the second switch 340 may be electrically connected to the second segment 320, the ground part, and a second port 352 of the first wireless communication circuit 350. According to an embodiment of the disclosure, the second switch 340 may optionally connect the second segment 320 to the ground part or the second port 352 of the first wireless communication circuit 350.

According to an embodiment of the disclosure, the first wireless communication circuit 350 may include a wireless communication circuit for transmitting and/or receiving a wireless signal. For example, the first wireless communication circuit 350 may be configured to transmit and/or receive a wireless signal of a frequency band (e.g., a frequency band of long term evolution (LTE) and/or 5G) used for a cellular network. According to an embodiment of the disclosure, the first wireless communication circuit 350 may transmit and/or receive a wireless signal by using an antenna formed from the first segment 310 and/or the second segment 320.

According to an embodiment of the disclosure, the first wireless communication circuit 350 may include the first port 351 and/or the second port 352. According to an embodiment of the disclosure, the first wireless communication circuit 350 may be electrically connected to the first segment 310 through the first port 351 and may be electrically connected to the second switch 340 through the second port 352. According to an embodiment of the disclosure, the first wireless communication circuit 350 may transmit and/or receive wireless signals of different frequency bands through the first port 351 and the second port 352, respectively.

According to an embodiment of the disclosure, the first wireless communication circuit 350 may be configured to operate in a first mode or a second mode. According to an embodiment of the disclosure, the first mode may be described as a first state, and the second mode may be described as a second state. For example, the first mode may be described as the first state in which the first wireless communication circuit 350 transmits and/or receives a wireless signal in the first frequency range, and the second mode may be described as the second state in which the first wireless communication circuit 350 transmits and/or receives a wireless signal in the first frequency range and the second frequency range.

According to an embodiment of the disclosure, the first mode may be configured such that the first wireless communication circuit 350 transmits and/or receives a wireless signal in a first frequency range by using a first antenna formed from the first segment 310 and a second antenna formed from the second segment 320. For example, the first wireless communication circuit 350 may transmit and/or receive a wireless signal of a first frequency band included in the first frequency range by using a first antenna formed from the first segment 310, and may transmit and/or receive a wireless signal of a second frequency band included in the first frequency range by using a second antenna formed from the second segment 320. Here, the first frequency band and the second frequency band included in the first frequency range may be frequency bands the same as each other or frequency bands different from each other.

According to an embodiment of the disclosure, the second mode may be configured such that the first wireless communication circuit 350 transmits and/or receives wireless signals in the first frequency range and the second frequency range by using a third antenna formed by electrically connecting the first segment 310 and the second segment 320. For example, the first wireless communication circuit 350 may transmit and/or receive a wireless signal of the first frequency band included in the first frequency range, the second frequency band included in the first frequency range, or a third frequency band included in the second frequency range by using the third antenna.

For example, the first frequency range may include the first frequency band (e.g., a mid frequency band of about 1.8 GHz to about 2.2 GHZ, mid band) and a second frequency band (e.g., a high frequency band of about 2.3 GHZ to about 2.7 GHZ, high band). The second frequency range may include the third frequency band (e.g., a low frequency band of about 0.7 GHZ to about 1.0 GHZ). The third frequency band may be lower than the first frequency band and the second frequency band. For example, the center frequency corresponding to the third frequency band may be lower than center frequencies corresponding to the first frequency band and the second frequency band. The first frequency band may be lower than the second frequency band. For example, the center frequency corresponding to the first frequency band may be lower than the center frequency corresponding to the second frequency band.

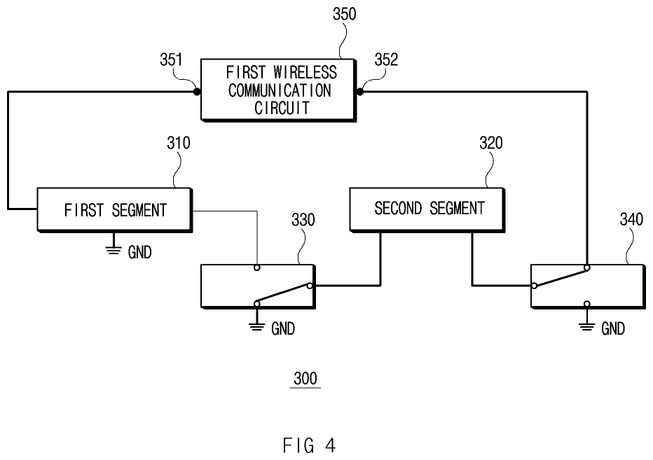

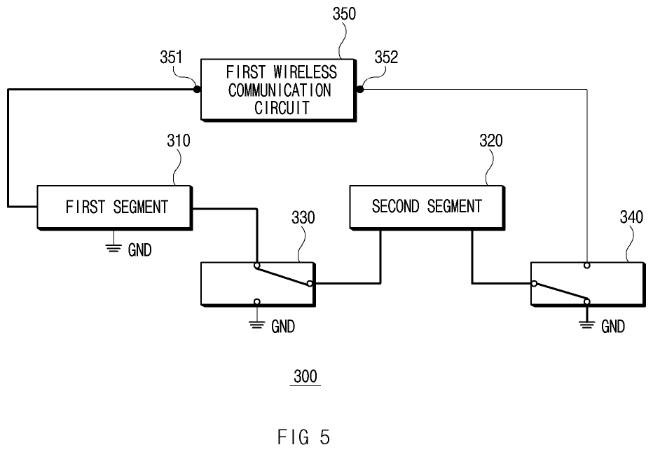

The first mode and the second mode in which the first wireless communication circuit 350 is configured to operate may be respectively described with reference to FIGS. 4 and 5, which will be described later.

In this specification, redundant descriptions associated with components having the same reference numerals will be omitted.

FIG. 4 is a block diagram illustrating a connection relationship between components when a first wireless communication circuit of an electronic device operates in a first mode according to an embodiment of the disclosure.

Referring to FIG. 4, the first port 351 of the first wireless communication circuit 350 may be electrically connected to the first segment 310. The first segment 310 may be electrically connected to the first port 351 of the first wireless communication circuit 350 at the first point, and may be electrically connected to a ground part at a second point. The first segment 310 may not be electrically connected to the second segment 320. The first segment 310 may be electrically open to the second segment 320. The second port 352 of the first wireless communication circuit 350 may be electrically connected to the second segment 320 through the second switch 340. The second segment 320 may be electrically connected to the second port 352 through the second switch 340 at the first point, and may be electrically connected to the ground part through the first switch 330 at the second point.

According to an embodiment of the disclosure, the first switch 330 may electrically connect the second segment 320 to the ground part, not the first segment 310. According to an embodiment of the disclosure, the second switch 340 may electrically connect the second segment 320 to the second port 352 of the first wireless communication circuit 350, not the ground part.

According to an embodiment of the disclosure, the electronic device 300 may include a first antenna. The first antenna may be at least partially formed from the first segment 310 that is electrically open to the second segment 320 through the first switch 330. The first wireless communication circuit 350 may transmit and/or receive a wireless signal in a first frequency range by using the first antenna. For example, the first wireless communication circuit 350 may transmit and/or receive a wireless signal of a first frequency band included in the first frequency range by using the first antenna.

According to an embodiment of the disclosure, the electronic device 300 may include a second antenna. The second antenna may be at least partially formed by the second segment 320 that is electrically open to the first segment 310 through the first switch 330. The first wireless communication circuit 350 may transmit and/or receive a wireless signal in the first frequency range by using the second antenna. For example, the first wireless communication circuit 350 may transmit and/or receive a wireless signal of a second frequency band, which is included in the first frequency range, by using the second antenna.

FIG. 5 is a block diagram illustrating a connection relationship between components when a first wireless communication circuit of an electronic device operates in a second mode according to an embodiment of the disclosure.

Referring to FIG. 5, the first segment 310 and the second segment 320 may be electrically connected to each other through the first switch 330. For example, the third point of the first segment 310 and the second point of the second segment 320 may be electrically connected to each other through the first switch 330. The first wireless communication circuit 350 is electrically connected to the first segment 310 through the first port 351, thereby being electrically connected to the first segment 310 and the second segment 320. The second segment 320 may not be electrically connected to the second port 352 of the first wireless communication circuit 350. The second segment 320 may be electrically open to the second port 352 of the first wireless communication circuit 350. The second segment 320 may be electrically connected to the ground part at the first point through the second switch 340.

According to an embodiment of the disclosure, the first switch 330 may electrically connect the second segment 320 to the first segment 310, not the ground part. According to an embodiment of the disclosure, the second switch 340 may electrically connect the second segment 320 to the ground part, not the second port 352 of the first wireless communication circuit 350.

According to an embodiment of the disclosure, the electronic device 300 may include a third antenna. The third antenna may be at least partially formed from the first segment 310 being electrically connected to the second segment 320 through the first switch 330, and the second segment 320 being electrically open to the second port 352 of the first wireless communication circuit 350 through the second switch 340. The first wireless communication circuit 350 may transmit and/or receive a wireless signal in the first frequency range and the second frequency range by using the third antenna. For example, the first wireless communication circuit 350 may transmit and/or receive a wireless signal of a first frequency band included in the first frequency range, the second frequency band included in the first frequency range, or the third frequency band included in the second frequency range by using the third antenna.

According to an embodiment of the disclosure, the electronic device 300 may control the first switch 330 and the second switch 340 such that the first wireless communication circuit 350 operates in the first mode when transmitting and/or receiving a wireless signal in the first frequency range. According to an embodiment of the disclosure, the electronic device 300 may control the first switch 330 and the second switch 340 such that the first wireless communication circuit 350 operates in the second mode when transmitting and/or receiving a wireless signal in the second frequency range.

The electronic device 300 according to an embodiment of the disclosure may include at least one processor (e.g., the processor 120 of FIG. 1) configured to control the first wireless communication circuit 350, the first switch 330, and the second switch 340. The at least one processor may be implemented separately from the first wireless communication circuit 350, or may be integrated with the first wireless communication circuit 350.

As described above, the electronic device 300 may expand the frequency band of a wireless signal that is capable of being transmitted and/or received by using the plurality of segments 310 and 320 connected to a plurality of ports of the first wireless communication circuit 350.

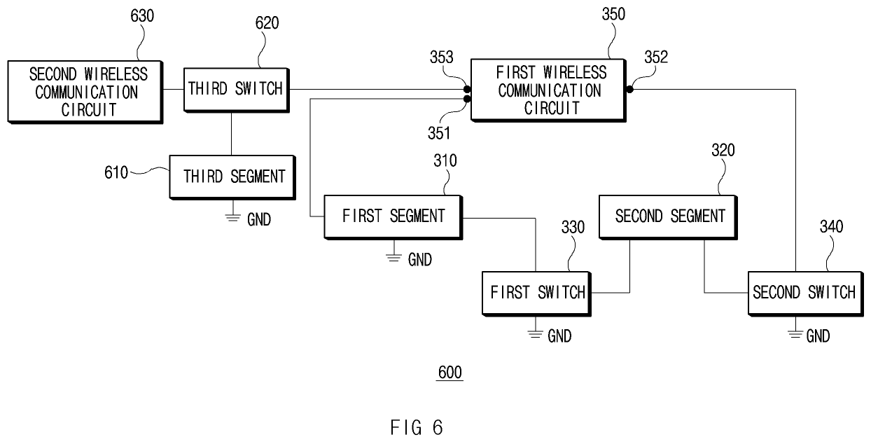

FIG. 6 is a block diagram of an electronic device according to an embodiment of the disclosure.

Referring to FIG. 6, an electronic device 600 (e.g., the electronic device 101 in FIG. 1, the electronic device 200 in FIG. 2, or the electronic device 300 in FIG. 3) may include the first segment 310, the second segment 320, a third segment 610 (e.g., the third segment 223 in FIG. 2), the first switch 330, the second switch 340, a third switch 620, the first wireless communication circuit 350, and/or a second wireless communication circuit 630 (e.g., the wireless communication module 192 in FIG. 1).

According to an embodiment of the disclosure, the third segment 610 may be electrically connected to the third switch 620 and a ground part. For example, the third segment 610 may be electrically connected to the third switch 620 at a first point. The third segment 610 may be electrically connected to the ground part at a second point.

According to an embodiment of the disclosure, the third segment 610 may radiate an electrical signal received from the first wireless communication circuit 350 or the second wireless communication circuit 630 into external space. According to an embodiment of the disclosure, the third segment 610 may have a specified length. For example, the third segment 610 may have a length capable of transmitting and/or receiving wireless signals in a first frequency range and a third frequency range. Here, the third frequency range may include a frequency band used for Wi-Fi communication.

According to an embodiment of the disclosure, the third switch 620 may be electrically connected to a third port 353 of the first wireless communication circuit 350, the third segment 610, and the second wireless communication circuit 630. According to an embodiment of the disclosure, the third switch 620 may selectively connect the third segment 610 to the third port 353 of the first wireless communication circuit 350 or the second wireless communication circuit 630.

According to an embodiment of the disclosure, the first wireless communication circuit 350 may transmit and/or receive a wireless signal by using an antenna formed from the first segment 310, the second segment 320, and/or the third segment 610.

According to an embodiment of the disclosure, the first wireless communication circuit 350 may include the first port 351, the second port 352, and/or the third port 353. According to an embodiment of the disclosure, the first wireless communication circuit 350 may be electrically connected to the first segment 310 through the first port 351, may be electrically connected to the second switch 340 through the second port 352, and may be electrically connected to the third switch 620 through the third port 353. According to an embodiment of the disclosure, the first wireless communication circuit 350 may transmit and/or receive wireless signals of different frequency bands through the first port 351, the second port 352, and the third port 353, respectively.

According to an embodiment of the disclosure, the first wireless communication circuit 350 may be configured to operate in a first mode, a second mode, or a third mode. According to an embodiment of the disclosure, the first mode may be described as a first state, the second mode may be described as a second state, and the third mode may be described as a third state. For example, the first mode may be described as the first state in which the first wireless communication circuit 350 transmits and/or receives a wireless signal in the first frequency range, the second mode may be described as the second state in which the first wireless communication circuit 350 transmits and/or receives a wireless signal in the first frequency range and the second frequency range, and, the third mode may be described as the third state in which the first wireless communication circuit 350 transmits and/or receives a wireless signal in the first frequency range by using a plurality of antennas.

According to an embodiment of the disclosure, the third mode may be configured such that the first wireless communication circuit 350 transmits and/or receives wireless signals in the first frequency range and the second frequency range by using a third antenna formed by electrically connecting the first segment 310 and the second segment 320, and transmits and/or receives a wireless signal in the first frequency range by using a fourth antenna formed from the third segment 610. For example, the first wireless communication circuit 350 may transmit and/or receive a wireless signal of the first frequency band included in the first frequency range, the second frequency band included in the first frequency range, or a third frequency band included in the second frequency range by using the third antenna. Furthermore, the first wireless communication circuit 350 may transmit and/or receive a wireless signal of a first frequency band and a second frequency band, which are included in the first frequency range, by using the fourth antenna.

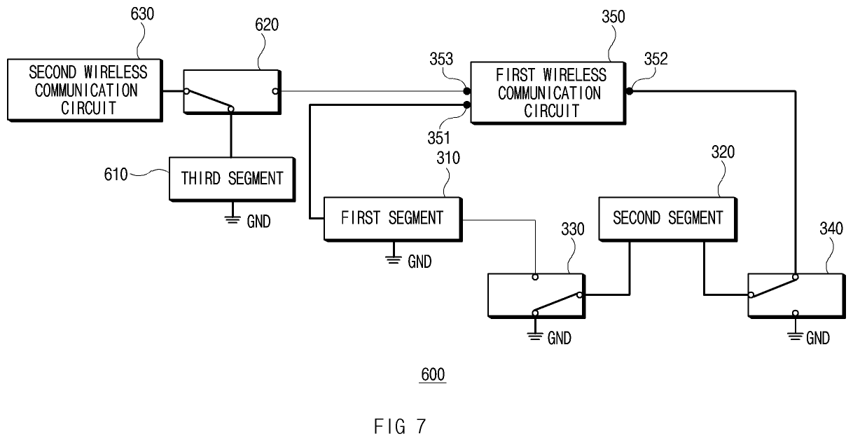

The first mode, the second mode, and the third mode in which the first wireless communication circuit 350 is configured to operate may be respectively described with reference to FIGS. 7, 8, and 9, which will be described later.

According to an embodiment of the disclosure, the second wireless communication circuit 630 may be a wireless communication circuit for transmitting and/or receiving a wireless signal. For example, the second wireless communication circuit 630 may generate a wireless signal of a frequency band (e.g., a frequency band of LTE and/or 5G) used for cellular networks and/or a frequency band used for Wi-Fi networks. According to an embodiment of the disclosure, the second wireless communication circuit 630 may transmit and/or receive a wireless signal by using an antenna formed from the third segment 610.

According to an embodiment of the disclosure, the second wireless communication circuit 630 may be electrically connected to the third switch 620. According to an embodiment of the disclosure, when the first wireless communication circuit 350 operates in the first mode or the second mode, the second wireless communication circuit 630 may be electrically connected to the third segment 610 via the third switch 620. In this case, the second wireless communication circuit 630 may transmit and/or receive a wireless signal in a third frequency range by using an antenna formed from the third segment 610. For example, the third frequency range may include a frequency band used for Wi-Fi networks.

In this specification, redundant descriptions associated with components having the same reference numerals will be omitted.

FIG. 7 is a block diagram illustrating a connection relationship between components when a first wireless communication circuit of an electronic device operates in a first mode according to an embodiment of the disclosure.

Referring to FIG. 7, the first port 351 of the first wireless communication circuit 350 may be electrically connected to the first segment 310. The first segment 310 may be electrically connected to the first port 351 of the first wireless communication circuit 350 at the first point, and may be electrically connected to a ground part at a second point. The first segment 310 may not be electrically connected to the second segment 320. The first segment 310 may be electrically open to the second segment 320. The second port 352 of the first wireless communication circuit 350 may be electrically connected to the second segment 320 through the second switch 340. The second segment 320 may be electrically connected to the second port 352 through the second switch 340 at the first point, and may be electrically connected to the ground part through the first switch 330 at the second point. The second wireless communication circuit 630 may be electrically connected to the third segment 610 through the third switch 620. The third segment 610 may be electrically connected to the third switch 620 at the first point and may be electrically connected to the ground part at the second point.

According to an embodiment of the disclosure, the first switch 330 may electrically connect the second segment 320 to the ground part, not the first segment 310. According to an embodiment of the disclosure, the second switch 340 may electrically connect the second segment 320 to the second port 352 of the first wireless communication circuit 350, not the ground part. According to an embodiment of the disclosure, the third switch 620 may electrically connect the third segment 610 to the second wireless communication circuit 630, not the third port 353 of the first wireless communication circuit 350.

According to an embodiment of the disclosure, the electronic device 600 may include a first antenna. The first antenna may be at least partially formed from the first segment 310 that is electrically open to the second segment 320 through the first switch 330. The first wireless communication circuit 350 may transmit and/or receive a wireless signal in a first frequency range by using the first antenna. For example, the first wireless communication circuit 350 may transmit and/or receive a wireless signal of a first frequency band included in the first frequency range by using the first antenna.

According to an embodiment of the disclosure, the electronic device 600 may include a second antenna. The second antenna may be at least partially formed by the second segment 320 that is electrically open to the first segment 310 through the first switch 330. The first wireless communication circuit 350 may transmit and/or receive a wireless signal in the first frequency range by using the second antenna. For example, the first wireless communication circuit 350 may transmit and/or receive a wireless signal of a second frequency band, which is included in the first frequency range, by using the second antenna.

According to an embodiment of the disclosure, the electronic device 600 may include a fifth antenna. The fifth antenna may be at least partially formed by the third segment 610 electrically connected through the third switch 620. The second wireless communication circuit 630 may transmit and/or receive a wireless signal in a third frequency range by using the fifth antenna. For example, the second wireless communication circuit 630 may transmit and/or receive a wireless signal of a fourth frequency band included in a third frequency range by using the fifth antenna.

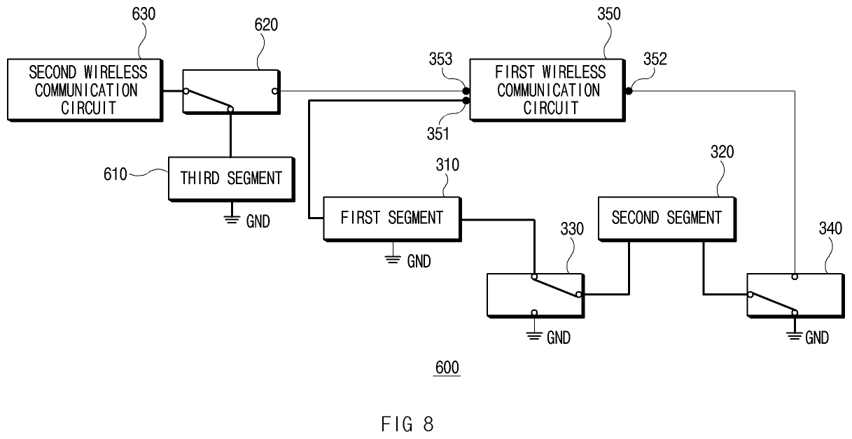

FIG. 8 is a block diagram illustrating a connection relationship between components when a first wireless communication circuit of an electronic device operates in a second mode according to an embodiment of the disclosure.

Referring to FIG. 8, the first segment 310 and the second segment 320 may be electrically connected to each other through the first switch 330. For example, the third point of the first segment 310 and the second point of the second segment 320 may be electrically connected to each other through the first switch 330. The first wireless communication circuit 350 is electrically connected to the first segment 310 through the first port 351, thereby being electrically connected to the first segment 310 and the second segment 320. The second segment 320 may not be electrically connected to the second port 352 of the first wireless communication circuit 350. The second segment 320 may be electrically open to the second port 352 of the first wireless communication circuit 350. The second segment 320 may be electrically connected to the ground part at the first point through the second switch 340. The second wireless communication circuit 630 may be electrically connected to the third segment 610 through the third switch 620. The third segment 610 may be electrically connected to the third switch 620 at the first point and may be electrically connected to the ground part at the second point.

According to an embodiment of the disclosure, the first switch 330 may electrically connect the second segment 320 to the first segment 310, not the ground part. According to an embodiment of the disclosure, the second switch 340 may electrically connect the second segment 320 to a ground part, not the second port 352 of the first wireless communication circuit 350. According to an embodiment of the disclosure, the third switch 620 may electrically connect the third segment 610 to the second wireless communication circuit 630, not the third port 353 of the first wireless communication circuit 350.

According to an embodiment of the disclosure, the electronic device 600 may include a third antenna. The third antenna may be at least partially formed from the first segment 310 being electrically connected to the second segment 320 through the first switch 330, and the second segment 320 being electrically open to the second port 352 of the first wireless communication circuit 350 through the second switch 340. The first wireless communication circuit 350 may transmit and/or receive a wireless signal in the first frequency range and the second frequency range by using the third antenna. For example, the first wireless communication circuit 350 may transmit and/or receive a wireless signal of a first frequency band included in the first frequency range, the second frequency band included in the first frequency range, or the third frequency band included in the second frequency range by using the third antenna.

According to an embodiment of the disclosure, the electronic device 600 may include a fifth antenna. The fifth antenna may be at least partially formed by the third segment 610 electrically connected through the third switch 620. The second wireless communication circuit 630 may transmit and/or receive a wireless signal in a third frequency range by using the fifth antenna. For example, the second wireless communication circuit 630 may transmit and/or receive a wireless signal of a fourth frequency band included in a third frequency range by using the fifth antenna.

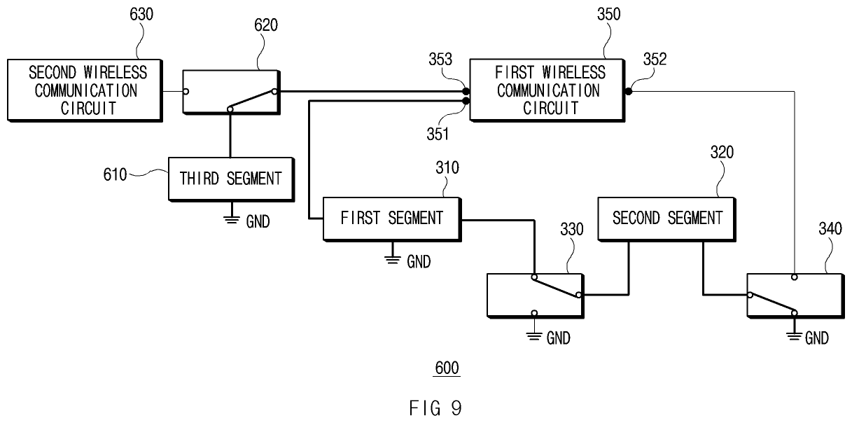

FIG. 9 is a block diagram illustrating a connection relationship between components when a first wireless communication circuit of an electronic device operates in a third mode according to an embodiment of the disclosure.

Referring to FIG. 9, the first segment 310 and the second segment 320 may be electrically connected to each other through the first switch 330. For example, the third point of the first segment 310 and the second point of the second segment 320 may be electrically connected to each other through the first switch 330. The first wireless communication circuit 350 is electrically connected to the first segment 310 through the first port 351, thereby being electrically connected to the first segment 310 and the second segment 320. The second segment 320 may not be electrically connected to the second port 352 of the first wireless communication circuit 350. The second segment 320 may be electrically open to the second port 352 of the first wireless communication circuit 350. The second segment 320 may be electrically connected to the ground part at the first point through the second switch 340. The third port 353 of the first wireless communication circuit 350 may be electrically connected to the third segment 610 through the third switch 620.

According to an embodiment of the disclosure, the first switch 330 may electrically connect the second segment 320 to the first segment 310, not the ground part. According to an embodiment of the disclosure, the second switch 340 may electrically connect the second segment 320 to a ground part, not the second port 352 of the first wireless communication circuit 350. According to an embodiment of the disclosure, the third switch 620 may electrically connect the third segment 610 to the third port 353 of the first wireless communication circuit 350, not the second wireless communication circuit 630.

According to an embodiment of the disclosure, the electronic device 600 may include a third antenna. The third antenna may be at least partially formed from the first segment 310 being electrically connected to the second segment 320 through the first switch 330, and the second segment 320 being electrically open to the second port 352 of the first wireless communication circuit 350 through the second switch 340. The first wireless communication circuit 350 may transmit and/or receive a wireless signal in the first frequency range and the second frequency range by using the third antenna. For example, the first wireless communication circuit 350 may transmit and/or receive a wireless signal of a first frequency band included in the first frequency range, the second frequency band included in the first frequency range, or the third frequency band included in the second frequency range by using the third antenna.

According to an embodiment of the disclosure, the electronic device 600 may include a fourth antenna. The fourth antenna may be at least partially formed from the third segment 610 electrically connected to the third port 353 of the first wireless communication circuit 350 through the third switch 620. The first wireless communication circuit 350 may transmit and/or receive a wireless signal in the first frequency range by using the fourth antenna. For example, the first wireless communication circuit 350 may transmit and/or receive a wireless signal of a first frequency band and a second frequency band, which are included in the first frequency range, by using the fourth antenna.

According to an embodiment of the disclosure, the electronic device 600 may control the first switch 330, the second switch 340, and the third switch 620 such that the first wireless communication circuit 350 operates in the first mode when transmitting and/or receiving a wireless signal in the first frequency range. According to an embodiment of the disclosure, the electronic device 600 may control the first switch 330, the second switch 340, and the third switch 620 such that the first wireless communication circuit 350 operates in the second mode when transmitting and/or receiving a wireless signal in the second frequency range. According to an embodiment of the disclosure, when the electronic device 600 performs carrier aggregation (CA) including a wireless signal of the second frequency range, the electronic device 600 may control the first switch 330, the second switch 340, and the third switch 620 such that the first wireless communication circuit 350 is capable of operating in a third mode.

As described above, the electronic device 600 may expand the frequency band of a wireless signal that is capable of being transmitted and/or received by using the plurality of segments 310, 320, and 610 connected to a plurality of ports of the first wireless communication circuit 350.

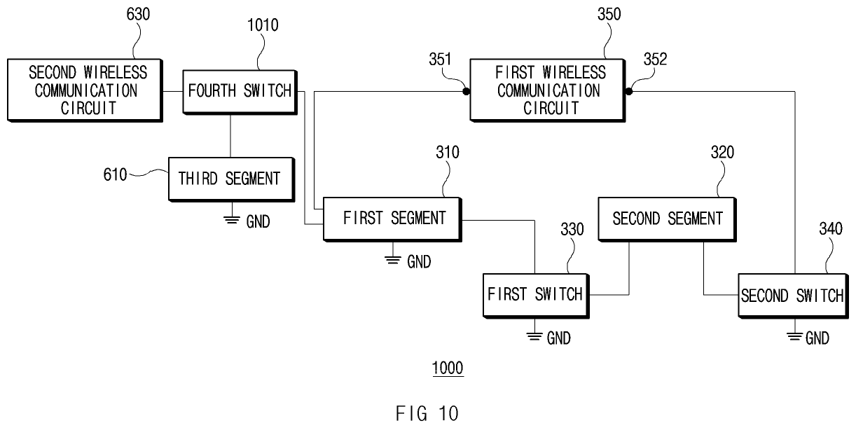

FIG. 10 is a block diagram of an electronic device according to an embodiment of the disclosure.

Referring to FIG. 10, an electronic device 1000 (e.g., the electronic device 101 in FIG. 1, the electronic device 200 in FIG. 2, or the electronic device 300 in FIG. 3) may include the first segment 310, the second segment 320, the third segment 610, the first switch 330, the second switch 340, a fourth switch 1010, the first wireless communication circuit 350, and the second wireless communication circuit 630.

According to an embodiment of the disclosure, the third segment 610 may be electrically connected to the fourth switch 1010 and a ground part.

According to an embodiment of the disclosure, the third segment 610 may radiate an electrical signal received from the first wireless communication circuit 350 or the second wireless communication circuit 630 into external space. According to an embodiment of the disclosure, the third segment 610 may have a specified length. For example, the third segment 610 may have a length capable of transmitting and/or receiving wireless signals in a first frequency range and a third frequency range. Here, the third frequency range may include a frequency band used for Wi-Fi communication.

According to an embodiment of the disclosure, the fourth switch 1010 may be electrically connected to the first segment 310, the third segment 610, and/or the second wireless communication circuit 630. According to an embodiment of the disclosure, the fourth switch 1010 may selectively connect the third segment 610 to the first segment 310 or the second wireless communication circuit 630.

According to an embodiment of the disclosure, the first wireless communication circuit 350 may transmit and/or receive a wireless signal by using an antenna formed from the first segment 310, the second segment 320, and/or the third segment 610.

According to an embodiment of the disclosure, the first wireless communication circuit 350 may include the first port 351 and/or the second port 352. According to an embodiment of the disclosure, the first wireless communication circuit 350 may be electrically connected to the first segment 310 through the first port 351 and may be electrically connected to the second switch 340 through the second port 352. According to an embodiment of the disclosure, the first wireless communication circuit 350 may transmit and/or receive wireless signals of different frequency bands through the first port 351 and the second port 352, respectively.

According to an embodiment of the disclosure, the first wireless communication circuit 350 may be configured to operate in a first mode, a second mode, or a fourth mode.

According to an embodiment of the disclosure, the fourth mode may be configured such that the first wireless communication circuit 350 transmits and/or receives wireless signals in the first frequency range and the second frequency range by using a sixth antenna formed by electrically connecting the first segment 310 and the third segment 610, and transmits and/or receives a wireless signal in the first frequency range by using a second antenna formed from the second segment 320. For example, the first wireless communication circuit 350 may transmit and/or receive a wireless signal of the first frequency band included in the first frequency range, the second frequency band included in the first frequency range, or a third frequency band included in the second frequency range by using the sixth antenna. Furthermore, the first wireless communication circuit 350 may transmit and/or receive a wireless signal of a first frequency band and a second frequency band, which are included in the first frequency range, by using the second antenna.

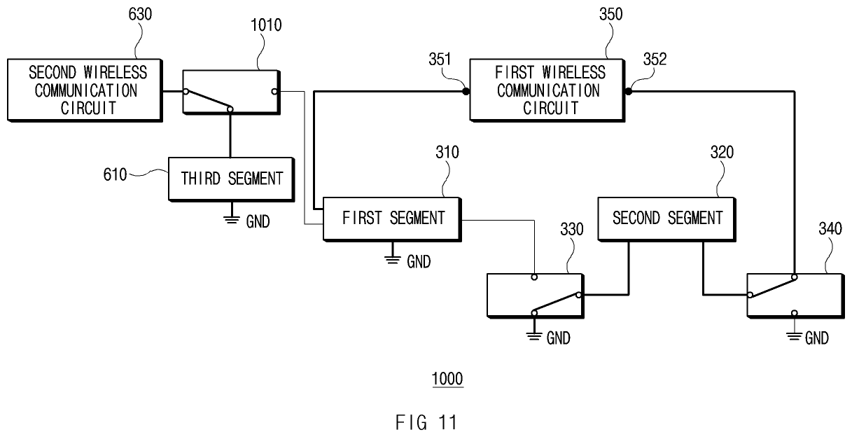

The first mode, the second mode, and the fourth mode in which the first wireless communication circuit 350 is configured to operate may be respectively described with reference to FIGS. 11, 12, and 13, which will be described later.

According to an embodiment of the disclosure, the second wireless communication circuit 630 may be a wireless communication circuit for transmitting and/or receiving a wireless signal. For example, the second wireless communication circuit 630 may generate a wireless signal of a frequency band (e.g., a frequency band of LTE and/or 5G) used for cellular networks and/or a frequency band used for Wi-Fi networks. According to an embodiment of the disclosure, the second wireless communication circuit 630 may transmit and/or receive a wireless signal by using an antenna formed from the third segment 610.

According to an embodiment of the disclosure, the second wireless communication circuit 630 may be electrically connected to the fourth switch 1010. According to an embodiment of the disclosure, when the first wireless communication circuit 350 operates in the first mode or the second mode, the second wireless communication circuit 630 may be electrically connected to the third segment 610 via the fourth switch 1010. In this case, the second wireless communication circuit 630 may transmit and/or receive a wireless signal in a third frequency range by using an antenna formed from the third segment 610. For example, the third frequency range may include a frequency band used for Wi-Fi networks.

FIG. 11 is a block diagram illustrating a connection relationship between components when a first wireless communication circuit of an electronic device operates in a first mode according to an embodiment of the disclosure.

Referring to FIG. 11, the first port 351 of the first wireless communication circuit 350 may be electrically connected to the first segment 310. The first segment 310 may be electrically connected to the first port 351 of the first wireless communication circuit 350 at the first point, and may be electrically connected to a ground part at a second point. The first segment 310 may not be electrically connected to the second segment 320. The first segment 310 may be electrically open to the second segment 320. The second port 352 of the first wireless communication circuit 350 may be electrically connected to the second segment 320 through the second switch 340. The second segment 320 may be electrically connected to the second port 352 through the second switch 340 at the first point, and may be electrically connected to the ground part through the first switch 330 at the second point. The second wireless communication circuit 630 may be electrically connected to the third segment 610 through the fourth switch 1010. The third segment 610 may be electrically connected to the fourth switch 1010 at the first point and may be electrically connected to the ground part at the second point.

According to an embodiment of the disclosure, the first switch 330 may electrically connect the second segment 320 to the ground part, not the first segment 310. According to an embodiment of the disclosure, the second switch 340 may electrically connect the second segment 320 to the second port 352 of the first wireless communication circuit 350, not the ground part. According to an embodiment of the disclosure, the fourth switch 1010 may electrically connect the third segment 610 to the second wireless communication circuit 630, not the first segment 310.

According to an embodiment of the disclosure, the electronic device 1000 may include a first antenna. The first antenna may be at least partially formed from the first segment 310 that is electrically open to the second segment 320 through the first switch 330. The first wireless communication circuit 350 may transmit and/or receive a wireless signal in a first frequency range by using the first antenna. For example, the first wireless communication circuit 350 may transmit and/or receive a wireless signal of a first frequency band included in the first frequency range by using the first antenna.

According to an embodiment of the disclosure, the electronic device 1000 may include a second antenna. The second antenna may be at least partially formed by the second segment 320 that is electrically open to the first segment 310 through the first switch 330. The first wireless communication circuit 350 may transmit and/or receive a wireless signal in the first frequency range by using the second antenna. For example, the first wireless communication circuit 350 may transmit and/or receive a wireless signal of a second frequency band, which is included in the first frequency range, by using the second antenna.

According to an embodiment of the disclosure, the electronic device 1000 may include a fifth antenna. The fifth antenna may be at least partially formed by the third segment 610 electrically connected through the fourth switch 1010. The second wireless communication circuit 630 may transmit and/or receive a wireless signal in a third frequency range by using the fifth antenna. For example, the second wireless communication circuit 630 may transmit and/or receive a wireless signal of a fourth frequency band included in a third frequency range by using the fifth antenna.

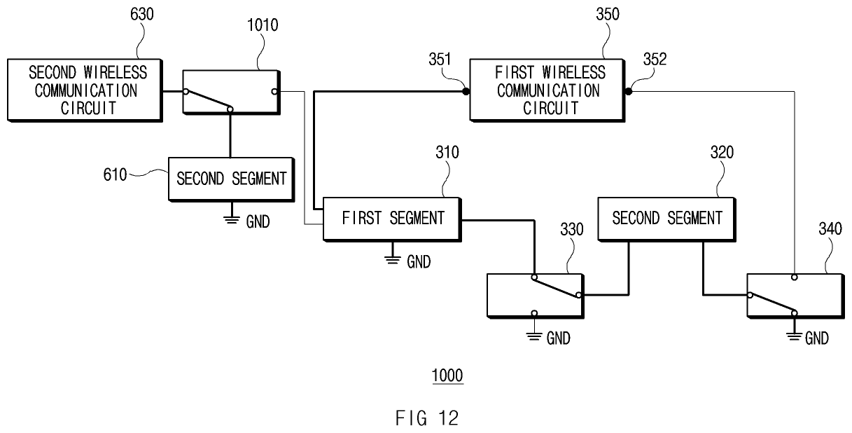

FIG. 12 is a block diagram illustrating a connection relationship between components when a first wireless communication circuit of an electronic device operates in a second mode according to an embodiment of the disclosure.

Referring to FIG. 12, the first segment 310 and the second segment 320 may be electrically connected to each other through the first switch 330. For example, the third point of the first segment 310 and the second point of the second segment 320 may be electrically connected to each other through the first switch 330. The first wireless communication circuit 350 is electrically connected to the first segment 310 through the first port 351, thereby being electrically connected to the first segment 310 and the second segment 320. The second segment 320 may not be electrically connected to the second port 352 of the first wireless communication circuit 350. The second segment 320 may be electrically open to the second port 352 of the first wireless communication circuit 350. The second segment 320 may be electrically connected to the ground part at the first point through the second switch 340. The second wireless communication circuit 630 may be electrically connected to the third segment 610 through the fourth switch 1010. The third segment 610 may be electrically connected to the fourth switch 1010 at the first point and may be electrically connected to the ground part at the second point.

According to an embodiment of the disclosure, the first switch 330 may electrically connect the second segment 320 to the first segment 310, not the ground part. According to an embodiment of the disclosure, the second switch 340 may electrically connect the second segment 320 to a ground part, not the second port 352 of the first wireless communication circuit 350. According to an embodiment of the disclosure, the fourth switch 1010 may electrically connect the third segment 610 to the second wireless communication circuit 630, not the first segment 310.

According to an embodiment of the disclosure, the electronic device 1000 may include a third antenna. The third antenna may be at least partially formed from the first segment 310 being electrically connected to the second segment 320 through the first switch 330, and the second segment 320 being electrically open to the second port 352 of the first wireless communication circuit 350 through the second switch 340. The first wireless communication circuit 350 may transmit and/or receive a wireless signal in the first frequency range and the second frequency range by using the third antenna. For example, the first wireless communication circuit 350 may transmit and/or receive a wireless signal of a first frequency band included in the first frequency range, the second frequency band included in the first frequency range, or the third frequency band included in the second frequency range by using the third antenna.

According to an embodiment of the disclosure, the electronic device 1000 may include a fifth antenna. The fifth antenna may be at least partially formed by the third segment 610 electrically connected through the fourth switch 1010. The second wireless communication circuit 630 may transmit and/or receive a wireless signal in a third frequency range by using the fifth antenna. For example, the second wireless communication circuit 630 may transmit and/or receive a wireless signal of a fourth frequency band included in a third frequency range by using the fifth antenna.

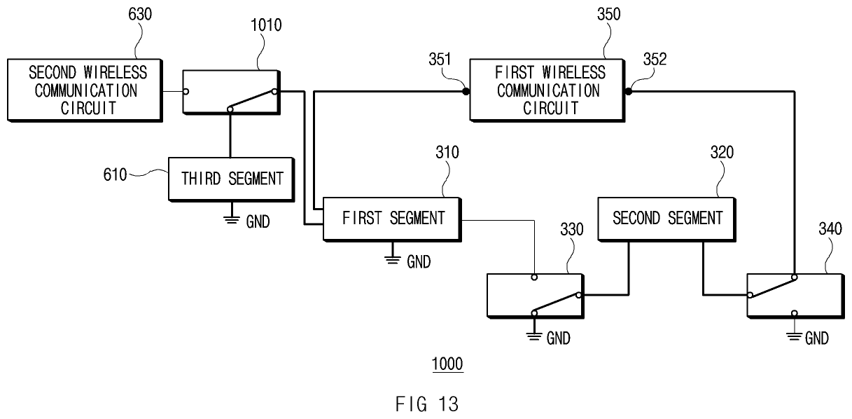

FIG. 13 is a block diagram illustrating a connection relationship between segments when a first wireless communication circuit of an electronic device operates in a fourth mode according to an embodiment of the disclosure.

Referring to FIG. 13, the first segment 310 and the third segment 610 may be electrically connected to each other through the fourth switch 1010. The first wireless communication circuit 350 is electrically connected to the first segment 310 through the first port 351, thereby being electrically connected to the first segment 310 and the third segment 610. The second port 352 of the first wireless communication circuit 350 may be electrically connected to the second segment 320 through the second switch 340. The second segment 320 may be electrically connected to the second port 352 through the second switch 340 at the first point, and may be electrically connected to the ground part through the first switch 330 at the second point.

According to an embodiment of the disclosure, the first switch 330 may electrically connect the second segment 320 to the ground part, not the first segment 310. According to an embodiment of the disclosure, the second switch 340 may electrically connect the second segment 320 to the second port 352 of the first wireless communication circuit 350, not the ground part. According to an embodiment of the disclosure, the fourth switch 1010 may electrically connect the third segment 610 to the first segment 310, not the second wireless communication circuit 630.

According to an embodiment of the disclosure, the electronic device 1000 may include a sixth antenna. The sixth antenna may be at least partially formed from the first segment 310 being electrically connected to the third segment 610 through the fourth switch 1010, and the third segment 610 being electrically open to the second wireless communication circuit 630 through the fourth switch 1010. The first wireless communication circuit 350 may transmit and/or receive a wireless signal in the first frequency range and the second frequency range by using the sixth antenna. For example, the first wireless communication circuit 350 may transmit and/or receive a wireless signal of a first frequency band included in the first frequency range, the second frequency band included in the first frequency range, or the third frequency band included in the second frequency range by using the sixth antenna.

According to an embodiment of the disclosure, the electronic device 1000 may include a second antenna. The second antenna may be at least partially formed by the second segment 320 that is electrically open to the first segment 310 through the first switch 330. The first wireless communication circuit 350 may transmit and/or receive a wireless signal in the first frequency range by using the second antenna. For example, the first wireless communication circuit 350 may transmit and/or receive a wireless signal of a second frequency band, which is included in the first frequency range, by using the second antenna.

According to an embodiment of the disclosure, the electronic device 1000 may control the first switch 330, the second switch 340, and the fourth switch 1010 such that the first wireless communication circuit 350 operates in the first mode when transmitting and/or receiving a wireless signal in the first frequency range. According to an embodiment of the disclosure, the electronic device 1000 may control the first switch 330, the second switch 340, and the fourth switch 1010 such that the first wireless communication circuit 350 operates in the second mode when transmitting and/or receiving a wireless signal in the second frequency range. According to an embodiment of the disclosure, when the electronic device 1000 performs carrier aggregation (CA) including a wireless signal of the second frequency range, the electronic device 600 may control the first switch 330, the second switch 340, and the fourth switch 1010 such that the first wireless communication circuit 350 is capable of operating in a fourth mode.

As described above, the electronic device 1000 may expand the frequency band of a wireless signal that is capable of being transmitted and/or received by using the plurality of segments 310, 320, and 610 connected to a plurality of ports of the first wireless communication circuit 350.

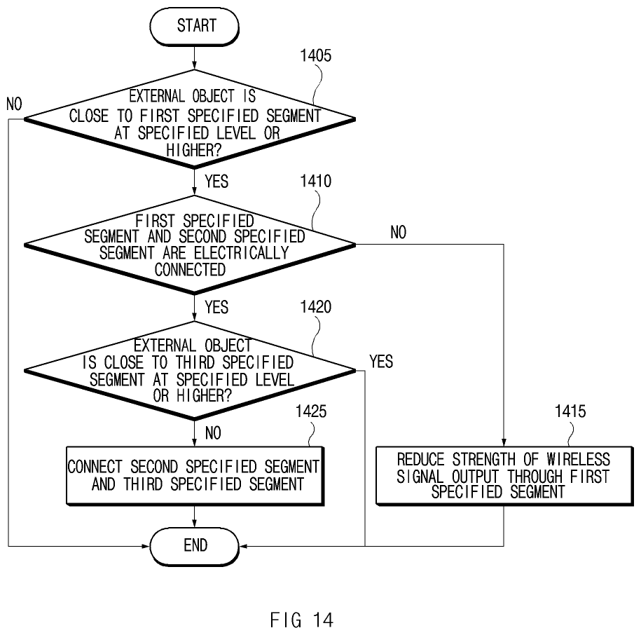

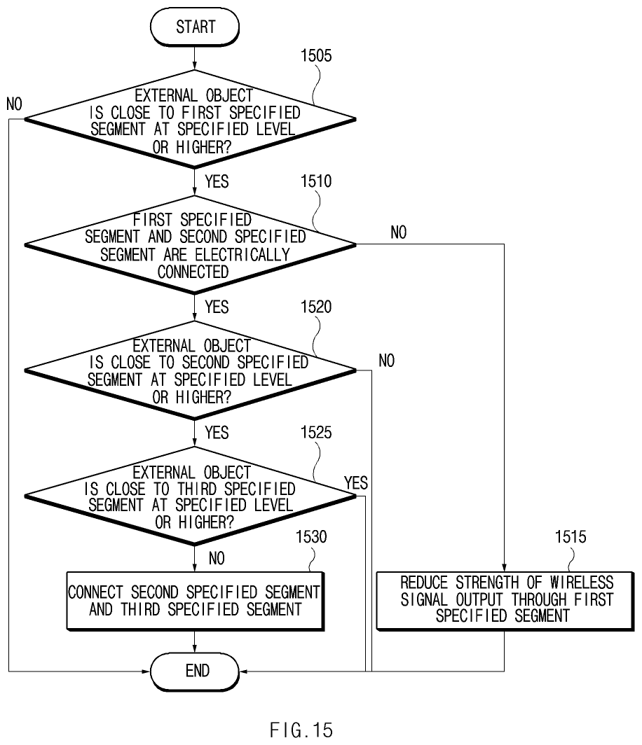

Hereinafter, an embodiment of the disclosure, in which an electronic device (e.g., the electronic device 101 of FIG. 1, the electronic device 200 of FIG. 2, the electronic device 300 of FIG. 3, the electronic device 600 of FIG. 6, or the electronic device 1000 of FIG. 10) changes a connection relationship between a plurality of segments based on whether an external object is in proximity, is described with reference to FIGS. 14 and 15. Operations of FIG. 14 may be performed sequentially or substantially at the same time. Operations of FIG. 15 may be performed sequentially or substantially at the same time. According to an embodiment of the disclosure, the order of operations in FIGS. 14 and 15 may be changed. For example, the order of operations 1405, 1410, and/or 1420 in FIG. 14 may be changed. For example, in FIG. 14, operation 1405 may be performed after operation 1410 or simultaneously with operation 1410. For example, the order of operations 1505, 1510, 1520, and/or 1525 in FIG. 15 may be changed. For example, in FIG. 15, operation 1510 may be performed after operation 1505 or simultaneously with operation 1505.

FIG. 14 is a flowchart of an operation of an electronic device according to an embodiment of the disclosure.

According to an embodiment of the disclosure, it may be understood that operations 1405 to 1425 are performed by a processor (e.g., the processor 120 of FIG. 1) of an electronic device.

Referring to FIG. 14, in operation 1405, the electronic device may determine whether an external object (e.g., a human body or an object) is close to a first specified segment at a specified level or higher. According to an embodiment of the disclosure, the first specified segment may be one of a plurality of segments (e.g., the plurality of segments 221, 222, 223, 224, 225, and/or 226 of FIG. 2) included in housing (e.g., the second housing 220 of FIG. 2) of the electronic device. According to an embodiment of the disclosure, the electronic device may perform wireless communication by using the first specified segment as an antenna.

According to an embodiment of the disclosure, the electronic device may determine whether the external object is close to the first specified segment at a specified level or higher, through a proximity sensor (e.g., the sensor module 176 of FIG. 1). According to an embodiment of the disclosure, the proximity sensor may generate a sensing signal for determining whether the external object is in proximity. The proximity sensor may generate the sensing signal for determining whether the external object is in proximity, through an electrode. According to an embodiment of the disclosure, the first specified segment may operate as the electrode, which is used by the proximity sensor to detect the proximity of the external object. According to an embodiment of the disclosure, the proximity sensor may generate the sensing signal indicating the capacitance of the first specified segment changing due to the external object. The electronic device may determine whether the external object is in proximity, based on the sensing signal generated by the proximity sensor. For example, when a capacitance change amount of the first specified segment is greater than or equal to a specified value, the electronic device may identify that the external object is close to the first specified segment at the specified level or higher.

When it is identified in operation 1405 that the external object is not close to the first specified segment at the specified level or higher (‘NO’), the electronic device may terminate the operation according to FIG. 14.

When it is identified in operation 1405 that the external object is close to the first specified segment at the specified level or higher (‘YES’), in operation 1410, the electronic device may determine whether the first specified segment and a second specified segment are electrically connected to each other. According to an embodiment of the disclosure, the second specified segment may be one segment, which excludes the first specified segment, from among the plurality of segments included in the housing of the electronic device. According to an embodiment of the disclosure, the second specified segment may be separated from the first specified segment by a non-conductive material (e.g., at least one gap 231, 232, 233, 234, 235, 236, 237, and/or 238 of FIG. 2). According to an embodiment of the disclosure, the electronic device may perform wireless communication by using the first specified segment and/or the second specified segment as an antenna.

When it is identified in operation 1410 that the first specified segment and the second specified segment are not electrically connected to each other (‘NO’), in operation 1415, the electronic device may reduce the strength of a wireless signal output through the first specified segment. According to an embodiment of the disclosure, the electronic device may transmit the wireless signal by using the first specified segment as an antenna. The electronic device may reduce the strength of the wireless signal transmitted through the first specified segment such that the strength of the wireless signal is smaller than or equal to specified strength. For example, the specified strength may be the strength of the wireless signal that satisfies the specific absorption rate (SAR) standard.

When it is identified in operation 1410 that the first specified segment and the second specified segment are electrically connected to each other (‘YES’), in operation 1420, the electronic device may determine whether the external object is close to a third specified segment at the specified level or higher. According to an embodiment of the disclosure, the third specified segment may be one segment, which excludes the first specified segment and the second specified segment, from among the plurality of segments included in the housing of the electronic device. According to an embodiment of the disclosure, the third specified segment may be separated from the first specified segment and/or the second specified segment by the non-conductive material (e.g., at least one gap 231, 232, 233, 234, 235, 236, 237, and/or 238 of FIG. 2). According to an embodiment of the disclosure, the electronic device may perform wireless communication by using the first specified segment, the second specified segment, and/or the third specified segment as an antenna.

According to an embodiment of the disclosure, the electronic device may determine whether the external object is close to the third specified segment at the specified level or higher, through the proximity sensor. According to an embodiment of the disclosure, the third specified segment may operate as an electrode, which is used by the proximity sensor to detect the proximity of the external object. According to an embodiment of the disclosure, the proximity sensor may generate a sensing signal indicating the capacitance of the third specified segment changing due to an external object. The electronic device may determine whether the external object is in proximity, based on the sensing signal generated by the proximity sensor. For example, when a capacitance change amount of the third specified segment is greater than or equal to a specified value, the electronic device may identify that the external object is close to the third specified segment at the specified level or higher.

When it is identified in operation 1420 that the external object is close to the third specified segment at the specified level or higher (‘YES’), the electronic device may terminate the operation according to FIG. 14. In this case, the electronic device may perform wireless communication by using an antenna formed by electrically connecting the first specified segment and the second specified segment to each other.

When it is identified in operation 1420 that the external object is not close to the third specified segment at the specified level or higher (‘NO’), in operation 1425, the electronic device may electrically connect the second specified segment and the third specified segment. For example, the electronic device may electrically connect all of the first specified segment, the second specified segment, and the third specified segment. For another example, the electronic device may disconnect the electrical connection between the first specified segment and the second specified segment, and may electrically connect the second specified segment and the third specified segment. According to an embodiment of the disclosure, the electronic device may perform wireless communication by using an antenna formed by electrically connecting the second specified segment and the third specified segment.

Through such the operations, the electronic device may improve communication quality by replacing a segment, which is closer to an external object at a specified level or higher, from among segments, which are electrically connected to each other and operate as an antenna, with another segment.

FIG. 15 is a flowchart of an operation of an electronic device according to an embodiment of the disclosure.

According to an embodiment of the disclosure, it may be understood that operations 1505 to 1530 are performed by a processor (e.g., the processor 120 of FIG. 1) of an electronic device.

Referring to FIG. 15, in operation 1505, the electronic device may determine whether an external object (e.g., a human body or an object) is close to a first specified segment at a specified level or higher. According to an embodiment of the disclosure, the first specified segment may be one of a plurality of segments (e.g., the plurality of segments 221, 222, 223, 224, 225, and/or 226 of FIG. 2) included in housing (e.g., the second housing 220 of FIG. 2) of the electronic device. According to an embodiment of the disclosure, the electronic device may perform wireless communication by using the first specified segment as an antenna.

According to an embodiment of the disclosure, the electronic device may determine whether the external object is close to the first specified segment at a specified level or higher, through a proximity sensor (e.g., the sensor module 176 of FIG. 1). According to an embodiment of the disclosure, the proximity sensor may generate a sensing signal for determining whether the external object is in proximity. The proximity sensor may generate the sensing signal for determining whether the external object is in proximity, through an electrode. According to an embodiment of the disclosure, the first specified segment may operate as the electrode, which is used by the proximity sensor to detect the proximity of the external object. According to an embodiment of the disclosure, the proximity sensor may generate the sensing signal indicating the capacitance of the first specified segment changing due to the external object. The electronic device may determine whether the external object is in proximity, based on the sensing signal generated by the proximity sensor. For example, when a capacitance change amount of the first specified segment is greater than or equal to a specified value, the electronic device may identify that the external object is close to the first specified segment at the specified level or higher.

When it is identified in operation 1505 that the external object is not close to the first specified segment at the specified level or higher (‘NO’), the electronic device may terminate the operation according to FIG. 15.

When it is identified in operation 1505 that the external object is close to the first specified segment at the specified level or higher (‘YES’), in operation 1510, the electronic device may determine whether the first specified segment and a second specified segment are electrically connected to each other. According to an embodiment of the disclosure, the second specified segment may be one segment, which excludes the first specified segment, from among the plurality of segments included in the housing of the electronic device. According to an embodiment of the disclosure, the second specified segment may be separated from the first specified segment by a non-conductive material (e.g., at least one gap 231, 232, 233, 234, 235, 236, 237, and/or 238 of FIG. 2). According to an embodiment of the disclosure, the electronic device may perform wireless communication by using the first specified segment and/or the second specified segment as an antenna.

When it is identified in operation 1510 that the first specified segment and the second specified segment are not electrically connected to each other (‘NO’), in operation 1515, the electronic device may reduce the strength of a wireless signal output through the first specified segment. According to an embodiment of the disclosure, the electronic device may transmit the wireless signal by using the first specified segment as an antenna. The electronic device may reduce the strength of the wireless signal transmitted through the first specified segment such that the strength of the wireless signal is smaller than or equal to specified strength. For example, the specified strength may be the strength of the wireless signal that satisfies the specific absorption rate (SAR) standard.

When it is identified in operation 1510 that the first specified segment and the second specified segment are electrically connected to each other (‘YES’), in operation 1520, the electronic device may determine whether the external object is close to the second specified segment at the specified level or higher. According to an embodiment of the disclosure, the second specified segment may operate as an electrode, which is used by the proximity sensor to detect the proximity of the external object. According to an embodiment of the disclosure, the proximity sensor may generate the sensing signal indicating the capacitance of the second specified segment changing due to the external object. The electronic device may determine whether the external object is in proximity, based on the sensing signal generated by the proximity sensor. For example, when a capacitance change amount of the second specified segment is greater than or equal to a specified value, the electronic device may identify that the external object is close to the second specified segment at the specified level or higher.

When it is identified in operation 1520 that the external object is not close to the second specified segment at the specified level or higher (‘NO’), the electronic device may terminate the operation according to FIG. 15. In this case, the electronic device may perform wireless communication by using an antenna formed by electrically connecting the first specified segment and the second specified segment to each other.

When it is identified in operation 1520 that the external object is close to the second specified segment at the specified level or higher (‘YES’), in operation 1525, the electronic device may determine whether the external object is close to a third specified segment at the specified level or higher. According to an embodiment of the disclosure, the third specified segment may be one segment, which excludes the first specified segment and the second specified segment, from among the plurality of segments included in the housing of the electronic device. According to an embodiment of the disclosure, the third specified segment may be separated from the first specified segment and/or the second specified segment by the non-conductive material (e.g., at least one gap 231, 232, 233, 234, 235, 236, 237, and/or 238 of FIG. 2). According to an embodiment of the disclosure, the electronic device may perform wireless communication by using the first specified segment, the second specified segment, and/or the third specified segment as an antenna.

According to an embodiment of the disclosure, the electronic device may determine whether the external object is close to the third specified segment at the specified level or higher, through the proximity sensor. According to an embodiment of the disclosure, the third specified segment may operate as an electrode, which is used by the proximity sensor to detect the proximity of the external object. According to an embodiment of the disclosure, the proximity sensor may generate a sensing signal indicating the capacitance of the third specified segment changing due to an external object. The electronic device may determine whether the external object is in proximity, based on the sensing signal generated by the proximity sensor. For example, when a capacitance change amount of the third specified segment is greater than or equal to a specified value, the electronic device may identify that the external object is close to the third specified segment at the specified level or higher.

When it is identified in operation 1525 that the external object is close to the third specified segment at the specified level or higher (‘YES’), the electronic device may terminate the operation according to FIG. 15. In this case, the electronic device may perform wireless communication by using an antenna formed by electrically connecting the first specified segment and the second specified segment to each other.

When it is identified in operation 1525 that the external object is not close to the third specified segment at the specified level or higher (‘NO’), in operation 1530, the electronic device may electrically connect the second specified segment and the third specified segment. For example, the electronic device may electrically connect all of the first specified segment, the second specified segment, and the third specified segment. For another example, the electronic device may disconnect the electrical connection between the first specified segment and the second specified segment, and may electrically connect the second specified segment and the third specified segment. According to an embodiment of the disclosure, the electronic device may perform wireless communication by using an antenna formed by electrically connecting the second specified segment and the third specified segment.

Through such the operations, the electronic device may improve communication quality by replacing a segment, which is closer to an external object at a specified level or higher, from among segments, which are electrically connected to each other and operate as an antenna, with another segment.

According to an embodiment of the disclosure, an electronic device may include a housing including a conductive portion, the conductive portion including a first segment, and a second segment separated from the first segment by a first gap, a first switch that selectively connects the first segment and the second segment, a first wireless communication circuit including a first port and a second port, the first port being electrically connected to the first segment, and a second switch that selectively connects the second port and the second segment. The first wireless communication circuit may operate in a first mode or a second mode. The first mode may be configured to transmit and/or receive a wireless signal in a first frequency range by using a first antenna formed from the first segment electrically open to the second segment through the first switch, and to transmit and/or receive a wireless signal in the first frequency range by using a second antenna formed from the second segment electrically open to the first segment through the first switch and electrically connected to the second port through the second switch. The second mode may be configured to transmit and/or receive a wireless signal in the first frequency range and a second frequency range by using a third antenna formed from the first segment electrically connected to the second segment through the first switch and the second segment electrically open to the second port through the second switch. The second frequency range may be different from the first frequency range.

According to an embodiment of the disclosure, the conductive portion may include a third segment separated from the first segment and/or the second segment by a second gap. The first wireless communication circuit may include a third port. The electronic device may include a second wireless communication circuit, and a third switch connected to the third segment and selectively connecting the third segment to the third port of the first wireless communication circuit or the second wireless communication circuit.

According to an embodiment of the disclosure, the first wireless communication circuit may be configured to operate in the first mode, the second mode, or a third mode. The third mode may be configured to transmit and/or receive a wireless signal in the first frequency range and the second frequency range by using the third antenna formed from the first segment electrically connected to the second segment through the first switch and the second segment electrically open to the second port through the second switch, and to transmit and/or receive a wireless signal in the first frequency range by using a fourth antenna formed from the third segment electrically open to the second wireless communication circuit through the third switch and electrically connected to the third port through the third switch.

According to an embodiment of the disclosure, the conductive portion may include a third segment separated from the first segment and/or the second segment by a second gap. The electronic device may include a second wireless communication circuit, and a fourth switch connected to the third segment and selectively connecting the third segment to the first segment or the second wireless communication circuit.

According to an embodiment of the disclosure, the first wireless communication circuit may be configured to operate in the first mode, the second mode, or a fourth mode. The fourth mode may be configured to transmit and/or receive a wireless signal in the first frequency range and the second frequency range by using a fifth antenna formed from the third segment electrically connected to the first segment through the fourth switch, and the first segment electrically open to the second segment through the first switch, and to transmit and/or receive a wireless signal in the first frequency range by using the second antenna formed from the second segment electrically open to the first segment through the first switch and electrically connected to the second port through the second switch.

According to an embodiment of the disclosure, the first mode may be configured to transmit and/or receive a wireless signal in the first frequency range by using the first antenna formed from the first segment, which is electrically open to the second segment through the first switch and electrically open to the third segment through the fourth switch. The second mode may be configured to transmit and/or receive a wireless signal in the first frequency range and a second frequency range by using a third antenna formed from the first segment, which is electrically open to the third segment through the fourth switch and which is electrically connected to the second segment through the first switch, and the second segment electrically open to the second port through the second switch.

According to an embodiment of the disclosure, a minimum value of the first frequency range may be higher than a maximum value of the second frequency range.

According to an embodiment of the disclosure, the first gap may be filled with a non-conductive material.

According to an embodiment of the disclosure, the electronic device may include a ground part. The first segment may be connected to the ground part. The first switch may connect the first segment to the second segment or the ground part.

According to an embodiment of the disclosure, the first mode may be configured to transmit and/or receive a wireless signal in the first frequency range by using the first antenna formed from the first segment, which is electrically open to the second segment through the first switch and which is connected to the ground part, and may be configured to transmit and/or receive a wireless signal in the first frequency range by using the second antenna formed from the second segment, which is electrically open to the first segment through the first switch, which is connected to the ground part through the first switch, and which is electrically connected to the second port through the second switch.

According to an embodiment of the disclosure, the electronic device may include a ground part. The first segment may be connected to the ground part. The second switch may electrically connect the second segment to the second port or the ground part.

According to an embodiment of the disclosure, the second mode may be configured to transmit and/or receive a wireless signal in the first frequency range and the second frequency range by using the third antenna formed from the first segment electrically connected to the second segment through the first switch, and the second segment electrically open to the second port through the second switch and connected to the ground part through the second switch.

According to an embodiment of the disclosure, the electronic device may include a first housing and a second housing pivotably connected to the first housing. The second housing may include at least one connector for connecting an external device to the electronic device. The housing may be the second housing.

According to an embodiment of the disclosure, an electronic device may include a housing including a conductive portion, the conductive portion including a plurality of segments, and the plurality of segments being respectively separated by a plurality of gaps, a wireless communication circuit that performs wireless communication by using at least one of the plurality of segments as an antenna, a proximity sensor that detects whether an external object is in proximity, and a processor electrically connected to the wireless communication circuit and the proximity sensor. The processor may be configured to determine whether an external object is close to a first specified segment among the plurality of segments at a specified level or higher, through the proximity sensor, to determine whether the first specified segment is electrically connected to a second specified segment among the plurality of segments based on an external object being identified as being close to the first specified segment at the specified level or higher, to determine whether an external object is close to a third specified segment among the plurality of segments at the specified level or higher, based on the first specified segment being identified as being electrically connected to the second specified segment, and to electrically connect the second specified segment and the third specified segment, based on an external object being identified as being close to the third specified segment at less than the specified level.

According to an embodiment of the disclosure, the processor may be configured to disconnect a connection between the first specified segment and the second specified segment and may be configured to electrically connect the second specified segment and the third specified segment based on an external object being identified as being close to the third specified segment at less than the specified level.

According to an embodiment of the disclosure, the processor may be configured to determine whether an external object is close to the second specified segment at the specified level or higher, through the proximity sensor based on the first specified segment being identified as being electrically connected to the second specified segment, and to determine whether an external object is close to a third specified segment among the plurality of segments at the specified level or higher, based on the second specified segment being identified as being close to the second specified segment at the specified level or higher.

According to an embodiment of the disclosure, the wireless communication circuit may be configured to perform the wireless communication by using the second specified segment and the third specified segment, which are electrically connected, as the antenna.

According to an embodiment of the disclosure, the processor may be configured to reduce the strength of a wireless signal output through the first specified segment based on the first specified segment being identified as not being electrically connected to the second specified segment.

According to an embodiment of the disclosure, the first specified segment, the second specified segment, and the third specified segment may operate as an electrode used by the proximity sensor to detect whether an external object is in proximity.

According to an embodiment of the disclosure, the electronic device may include a first housing and a second housing pivotably connected to the first housing. The second housing may include at least one connector for connecting an external device to the electronic device. The housing may be the second housing.

The electronic device according to various embodiments of the disclosure disclosed in the disclosure may be various types of devices. The electronic device may include, for example, a portable communication device (e.g., a smartphone), a computer device, a portable multimedia device, a mobile medical appliance, a camera, a wearable device, or a home appliance. An electronic device according to an embodiment of the disclosure may not be limited to the above-described electronic devices.

Various embodiments of the disclosure and terms used herein are not intended to limit the technical features described in the disclosure to specific embodiments of the disclosure, and it should be understood that the embodiments and the terms include modification, equivalent, or alternative on the corresponding embodiments described herein. With regard to description of drawings, similar or related components may be marked by similar reference marks/numerals. In the disclosure, the expressions “A or B”, “at least one of A and B”, “at least one of A or B”, “A, B, or C”, “at least one of A, B, and C”, and “at least one of A, B, or C” may include any and all combinations of one or more of the associated listed items. The terms, such as “first” or “second” may be used to simply distinguish the corresponding component from the other component, but do not limit the corresponding components in other aspects (e.g., importance or order). When a component (e.g., a first component) is referred to as being “coupled with/to” or “connected to” another component (e.g., a second component) with or without the term of “operatively” or “communicatively”, it may mean that a component is connectable to the other component, directly (e.g., by wire), wirelessly, or through the third component.

In various embodiments of the disclosure, the term “module” used herein may include a unit, which is implemented with hardware, software, or firmware, and may be interchangeably used with the terms “logic”, “logical block”, “part”, or “circuit”. The “module” may be a minimum unit of an integrated part or may be a minimum unit of the part for performing one or more functions or a part thereof. For example, according to an embodiment of the disclosure, the module may be implemented in the form of an application-specific integrated circuit (ASIC).

Various embodiments of the disclosure may be implemented with software (e.g., program 140) including one or more instructions stored in a storage medium (e.g., internal memory 136 or external memory 138) readable by a machine (e.g., the electronic device 101). For example, the processor (e.g., the processor 120) of the machine (e.g., the electronic device 101) may call at least one instruction of the stored one or more instructions from a storage medium and then may execute the at least one instruction. This enables the machine to operate to perform at least one function depending on the called at least one instruction. The one or more instructions may include a code generated by a complier or a code executable by an interpreter. The machine-readable storage medium may be provided in the form of a non-transitory storage medium. Herein, ‘non-transitory’ just means that the storage medium is a tangible device and does not include a signal (e.g., electromagnetic waves), and this term does not distinguish between the case where data is semipermanently stored in the storage medium and the case where the data is stored temporarily.

According to an embodiment of the disclosure, a method according to various embodiments disclosed herein may be provided to be included in a computer program product. The computer program product may be traded between a seller and a buyer as a product. The computer program product may be distributed in the form of a machine-readable storage medium (e.g., compact disc read only memory (CD-ROM)) or may be distributed (e.g., downloaded or uploaded), through an application store (e.g., PlayStore™), directly between two user devices (e.g., smartphones), or online. In the case of on-line distribution, at least part of the computer program product may be at least temporarily stored in the machine-readable storage medium, such as the memory of a manufacturer's server, an application store's server, or a relay server or may be generated temporarily.

According to various embodiments of the disclosure, each component (e.g., a module or a program) of the above-described components may include a single entity or a plurality of entities, and some of the plurality of objects may be separately arranged on other components. According to various embodiments of the disclosure, one or more components of the above-described components or operations may be omitted, or one or more other components or operations may be added. Alternatively or additionally, a plurality of components (e.g., a module or a program) may be integrated into one component. In this case, the integrated component may perform one or more functions of each component of the plurality of components in the manner same as or similar to being performed by the corresponding component of the plurality of components prior to the integration. According to various embodiments of the disclosure, operations executed by modules, programs, or other components may be executed by a successive method, a parallel method, a repeated method, or a heuristic method. Alternatively, at least one or more of the operations may be executed in another order or may be omitted, or one or more operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing including a conductive portion, the conductive portion including a first segment and a second segment separated from the first segment by a first gap;
a first switch configured to selectively connect the first segment and the second segment;
a first wireless communication circuit including a first port and a second port, the first port being electrically connected to the first segment; and
a second switch configured to selectively connect the second port and the second segment,
wherein the first wireless communication circuit is configured to operate in a first mode or a second mode,
wherein the first mode is configured to:
transmit and/or receive a wireless signal in a first frequency range by using a first antenna formed from the first segment electrically open to the second segment through the first switch, and
transmit and/or receive a wireless signal in the first frequency range by using a second antenna formed from the second segment electrically open to the first segment through the first switch and electrically connected to the second port through the second switch,
wherein the second mode is configured to:
transmit and/or receive a wireless signal in the first frequency range and a second frequency range by using a third antenna formed from the first segment electrically connected to the second segment through the first switch and the second segment electrically open to the second port through the second switch, and
wherein the second frequency range is different from the first frequency range.

2. The electronic device of claim 1,
wherein the conductive portion includes a third segment separated from the first segment and/or the second segment by a second gap,
wherein the first wireless communication circuit includes a third port, and
wherein the electronic device further comprises:
a second wireless communication circuit, and
a third switch connected to the third segment and configured to selectively connect the third segment to the third port of the first wireless communication circuit or the second wireless communication circuit.

3. The electronic device of claim 2,
wherein the first wireless communication circuit is configured to operate in the first mode, the second mode, or a third mode, and
wherein the third mode is configured to:
transmit and/or receive a wireless signal in the first frequency range and the second frequency range by using the third antenna formed from the first segment electrically connected to the second segment through the first switch and the second segment electrically open to the second port through the second switch, and
transmit and/or receive a wireless signal in the first frequency range by using a fourth antenna formed from the third segment electrically open to the second wireless communication circuit through the third switch and electrically connected to the third port through the third switch.

4. The electronic device of claim 1,
wherein the conductive portion includes a third segment separated from the first segment and/or the second segment by a second gap, and
wherein the electronic device further comprises:
a second wireless communication circuit, and
a fourth switch connected to the third segment and configured to selectively connect the third segment to the first segment or the second wireless communication circuit.

5. The electronic device of claim 4,
wherein the first wireless communication circuit is configured to operate in the first mode, the second mode, or a fourth mode, and
wherein the fourth mode is configured to:
transmit and/or receive a wireless signal in the first frequency range and the second frequency range by using a fifth antenna formed from the third segment electrically connected to the first segment through the fourth switch, and the first segment electrically open to the second segment through the first switch, and
transmit and/or receive a wireless signal in the first frequency range by using the second antenna formed from the second segment electrically open to the first segment through the first switch and electrically connected to the second port through the second switch.

6. The electronic device of claim 5,
wherein the first mode is configured to:
transmit and/or receive a wireless signal in the first frequency range by using the first antenna formed from the first segment, which is electrically open to the second segment through the first switch and electrically open to the third segment through the fourth switch, and
wherein the second mode is configured to:
transmit and/or receive a wireless signal in the first frequency range and the second frequency range by using a third antenna formed from the first segment, which is electrically open to the third segment through the fourth switch and which is electrically connected to the second segment through the first switch, and the second segment electrically open to the second port through the second switch.

7. The electronic device of claim 1, wherein a minimum value of the first frequency range is higher than a maximum value of the second frequency range.

8. The electronic device of claim 1, wherein the first gap is filled with a non-conductive material.

9. The electronic device of claim 1, further comprising:
a ground part,
wherein the first segment is connected to the ground part, and
wherein the first switch is configured to connect the first segment to the second segment or the ground part.

10. The electronic device of claim 9, wherein the first mode is configured to:
transmit and/or receive a wireless signal in the first frequency range by using the first antenna formed from the first segment, which is electrically open to the second segment through the first switch and which is connected to the ground part; and
transmit and/or receive a wireless signal in the first frequency range by using the second antenna formed from the second segment, which is electrically open to the first segment through the first switch, which is connected to the ground part through the first switch, and which is electrically connected to the second port through the second switch.

11. The electronic device of claim 1, further comprising:
a ground part,
wherein the first segment is connected to the ground part, and
wherein the second switch is configured to electrically connect the second segment to the second port or the ground part.

12. The electronic device of claim 11, wherein the second mode is configured to:
transmit and/or receive a wireless signal in the first frequency range and the second frequency range by using the third antenna formed from the first segment electrically connected to the second segment through the first switch, and the second segment electrically open to the second port through the second switch and connected to the ground part through the second switch.

13. The electronic device of claim 1, further comprising:
a first housing; and
a second housing pivotably connected to the first housing,
wherein the second housing includes at least one connector for connecting an external device to the electronic device, and
wherein the housing is the second housing.

14. An electronic device comprising:
a housing including a conductive portion, the conductive portion including a plurality of segments, and the plurality of segments being respectively separated by a plurality of gaps;
a wireless communication circuit configured to perform wireless communication by using at least one of the plurality of segments as an antenna;
a proximity sensor configured to detect whether an external object is in proximity;
memory storing one or more computer programs; and
one or more processors communicatively coupled to the wireless communication circuit and the proximity sensor,
wherein the one or more computer programs include computer-executable instructions that, when executed by the one or more processors individually or collectively, cause the electronic device to:
determine whether the external object is close to a first specified segment among the plurality of segments at a specified level or higher, through the proximity sensor,
determine whether the first specified segment is electrically connected to a second specified segment among the plurality of segments based on the external object being identified as being close to the first specified segment at the specified level or higher,
determine whether the external object is close to a third specified segment among the plurality of segments at the specified level or higher, based on the first specified segment being identified as being electrically connected to the second specified segment, and
electrically connect the second specified segment and the third specified segment, based on the external object being identified as being close to the third specified segment at less than the specified level.

15. The electronic device of claim 14, wherein the one or more computer programs further include computer-executable instructions that, when executed by the one or more processors individually or collectively, cause the electronic device to:
disconnect a connection between the first specified segment and the second specified segment and electrically connect the second specified segment and the third specified segment based on the external object being identified as being close to the third specified segment at less than the specified level.

16. The electronic device of claim 15,
wherein the plurality of gas include a first gap and a second gap,
wherein the second specified segment is separated from the first specified segment by the first gap, and
wherein the third specified segment is separated from the first specified segment and/or the second specified segment by the second gap.

17. The electronic device of claim 16, further comprising:
a first switch configured to selectively connect the first specified segment and the second specified segment;
a first wireless communication circuit including a first port and a second port, the first port being electrically connected to the first specified segment; and
a second switch configured to selectively connect the second port and the second specified segment.

18. One or more non-transitory computer-readable storage media storing one or more computer programs including computer-executable instructions that, when executed by one or more processors of an electronic device individually or collectively, cause the electronic device to perform operations, the operations comprising:
determining whether an external object is close to a first specified segment among a plurality of segments at a specified level or higher, through a proximity sensor, the plurality of segments included in a conductive portion of a housing of the electronic device and separated by plurality of gapes;
determining whether the first specified segment is electrically connected to a second specified segment among the plurality of segments based on the external object being identified as being close to the first specified segment at the specified level or higher;
determining whether the external object is close to a third specified segment among the plurality of segments at the specified level or higher, based on the first specified segment being identified as being electrically connected to the second specified segment; and
electrically connecting the second specified segment and the third specified segment, based on the external object being identified as being close to the third specified segment at less than the specified level.

19. The one or more non-transitory computer-readable storage media of claim 18, the operations further comprising:
disconnecting a connection between the first specified segment and the second specified segment and electrically connect the second specified segment and the third specified segment based on the external object being identified as being close to the third specified segment at less than the specified level.

20. The one or more non-transitory computer-readable storage media of claim 19,
wherein the plurality of gaps include a first gap and a second gap,
wherein the second specified segment is separated from the first specified segment by the first gap, and
wherein the third specified segment is separated from the first specified segment and/or the second specified segment by the second gap.
